(19) United States
(12) Patent Application Publication
(10) Pub. No.: US 2002/0111946 A1
(43) Pub. Date: Aug. 15, 2002

(54) Systems and methods for a personal, universal, integrated organizer for legacy planning and storage

(76) Inventor: Jill Fallon, Arlington, MA (US)

Correspondence Address: Choate, Hall & Stewart, Exchange Place, 53 State Street, Boston, MA, 02109, US

(21) Appl. No.: 09/966,668

(22) Filed: Sep. 28, 2001

Related U.S. Application Data
(60) Provisional application No. 60/236,943, filed on Sep. 29, 2000.

(51) Int. Cl. G06F 7/00

(52) U.S. Cl. 707/9

(57) ABSTRACT

The invention provides a system and method for assisting individuals in putting their affairs in order using a universal integrated organizer with personal legacy planning and personal on-line storage. The system includes a secure Web site that allow a user to assemble and submit documents, records, lists of information, etc., that form part of a comprehensive estate plan and also documents of a personal nature. Certain documents and information such as medical records, tax returns, etc., can also be submitted by other individuals. The system organizes the information and documents in a set of folders such as a Personal Folder, Medical Folder, Legal Folder, and Financial Folder. The system encrypts the information before transmission to the Web site. The information is stored securely and can subsequently be accessed and changed only by the user. Upon the death or incapacitation of the user or other designated condition , the stored information can be accessed by authorized representatives such as a trusted individual through financial institutions such as a bank or insurance company. In certain embodiments of the invention public key cryptography is used for security purposes.

### CROSS-REFERENCE TO RELATED APPLICATION

The present application claims priority to U.S. Provisional Application Serial No. 60/236,943, filed Sep. 29, 2000, which is hereby incorporated by reference.

### BACKGROUND OF THE INVENTION

It is a widely recognized fact that most individuals find it uncomfortable to contemplate the thought of death. In addition, keeping track of one's personal financial affairs becomes increasingly complicated as one ages and accumulates assets. These factors frequently translate into an individual's failure to make appropriate and timely plans for the disposition of his or her estate. Although most people are aware of the importance of having a will, more than 70% of adult Americans are currently intestate (lacking a will). In addition, many individuals are unaware of the other types of documents that constitute an important part of a good estate plan or what constitutes estate planning. Estate planning is a two-part process. One part involves planning for the management and disposition of one's property during one's lifetime and after one's death. The second part is planning for one's own personal and health care in the event one becomes incapacitated. With the aging of America, the magnitude of this problem is likely to increase in the coming years. With the mapping of the human genome, one's DNA and one's medical history have become important even critical information to pass on to one's progeny.

When an individual dies, one of the most difficult tasks for the executor or next of kin is locating assets, relevant documents and important records, etc. These items are frequently dispersed in a variety of locations. Such locations may range from secure storage such as a safety deposit box in a bank or a “strongbox” with a key (which may itself be hard to find) to locations that may be substantially less secure, e.g., paper-based file systems, envelopes, or computer disks. In many of these instances the documents themselves may be vulnerable. Paper files can be lost or destroyed. Keys can be misplaced or stolen. Computer software may become obsolete and no longer available.

Estate planning with frequent reviews has heretofore been considered the province of the very rich. However, regardless of the magnitude of the estate, every good estate plan requires frequent review as children are born, people are married or divorced, parents or spouses die, assets are inherited or otherwise acquired, laws change, named executors, beneficiaries, or trustees die, retire, or move, etc. In addition, there are changes in circumstances or wishes that should be reflected in the estate plan documents. Few individuals have the discipline, knowledge, and organizational skills required to maintain their estate plan documents in an appropriate manner at all times.

Failure to plan effectively for one's estate can have a variety of undesirable consequences. If one becomes incapacitated, it can be very difficult for one's family to pay one's bills, to cash one's checks, to operate one's business or to locate and provide the appropriate medical and nursing care. If one dies with an out-of-date will, costly and time-consuming delays can result when it is not possible to locate legal documents, the designated administrators or legatees, or financial records. If one has remarried, the second spouse may fail to leave any money to the children of the first marriage without proper planning. Without an up-to-date health care proxy, one's death may be painful and prolonged with suffering. With appreciated stock and housing, many millions of people have taxable estates and don't know they could plan to reduce taxes. Furthermore, the burden of locating, identifying, and sorting through documents frequently falls on one or two grieving relatives at a time when they are least equipped to cope with it. The adult children of elderly parents are frequently reluctant to ask their parents for the detailed information necessary to streamline this process and to insure that their parents will be properly taken care of if either or both becomes incapacitated or that their assets can be found and distributed to the people to whom the parents want them to be given.

Thus there exists a need for a system that would allow a user to organize his or her personal financial, legal, and medical information in a fashion that will allow a lawyer, accountant or financial advisor to review it quickly so that proper professional advice can be given. One of the most difficult problems a professional advisor faces is obtaining the client's data and information, the foundation of all planning. When a professional must organize slips of paper, reports, documents, returns, certificates, etc., it is certain that the professional fees are significantly higher. Once organized, and after professional advice is given, there exists the need to be able to easily review the basic information, the foundation of the professional plans, so that one can quickly determine whether revisions are necessary. There is also a need for a means of increasing the likelihood that the estate plan decided upon is followed through, by completing the necessary tasks of changing account names and designating beneficiaries for all insurance policies and retirement plans.

Thus, there exists a need for a system that would allow a user to organize information and to store and find documents related to personal legacy planning in a comprehensive, permanent, secure, yet readily accessible manner. Furthermore, there exists a need for a system that would assist the user in selecting appropriate documents and assist the user in maintaining the documents in a state that accurately reflects the user's circumstances and also changing conditions such as changes in tax laws or family circumstances. In addition, there exists a need for a personal legacy planning system that would allow a user to designate a trusted entity such as an individual or institution that can access the documents in the event of the user's death.

### SUMMARY OF THE INVENTION

The present invention addresses the foregoing needs by providing methods and systems for assisting a user with personal legacy planning and organization of personal information. In certain preferred embodiments of the invention, the system serves as a universal personal integrated organizer. In certain embodiments of the invention the system and methods allow the aggregation of personal information from a diverse array of sources, e.g., they allow professionals such as a user's physician, accountant, etc., to contribute information that can be incorporated into the organizer. The invention organizes and integrates all the user's important information, records and documents—legal, financial, medical, and personal—in an individual database which is stored in a private, secure fashion. The individual's data storage space may be referred to herein as an e-vault.

In one aspect the invention is a system (e.g., a method, apparatus, and/or computer-executable process steps) that: (1) transmits a series of requests to a user over a computer network, the requests comprising requests for informational items appropriate for inclusion in a personal legacy plan; (2) receives, over the computer network, informational items appropriate for inclusion in a personal legacy plan from the user; and (3) stores the informational items on a secure server, wherein access to the informational items is restricted to the user by whom they were submitted. The informational items can include documents such as a will, trust, etc., related to estate planning. However, as described further below, a wide variety of informational items can be included. In certain embodiments of the invention the system need not transmit requests. The system may provide a list of suggested items to include, or the user may have complete freedom to include any desired items. In certain embodiments of the invention, the inventive system creates standardized templates for user-organized information, which information may include any items submitted by the user (or, under certain circumstances, information submitted by others). In certain embodiments of the invention the informational items are encrypted prior to transmission. In a preferred embodiment of the invention the user designates one or more trusted individuals who are granted access to the informational items upon the occurrence of a condition predetermined by the user, e.g., the death or incapacitation of the user.

In another aspect, the system provides a Web site that assists a user in the entry of personal information and the organization and storage of personal documents. The Web site comprises a set of Web pages that request informational items from a user and/or allows the user to submit informational items, the informational items including items appropriate for inclusion in a personal legacy plan. The items are stored securely on a computer-readable medium. Access to the informational items is restricted to the user and to one or more trusted individuals who are granted access upon the occurrence of a condition predetermined by the user. In certain embodiments of the invention, the Web site allows individuals and, optionally, their advisors, to understand the nature of specific life event changes from birth to death. For people in transition, the Web site helps them manage those difficult times with maps, guides, checklists, selected resources and links to appropriate Web sites (e.g., those determined to contain the most reliable information). For advisors, the invention offers a new approach to building trusted financial relationships.

Although the invention may be implemented as a stand-alone Web site and service, in preferred embodiments of the invention the service is provided through and/or in conjunction with a partner or sponsor such as an existing institution or service, e.g., a financial planner, investment advisor, law firm, insurance company, accountant, health care provider, financial portal, etc. In such embodiments the service may be accessed through a Web site provided by the partner. In certain embodiments of the invention the institution or service acts as a trusted entity which, though not itself having access to the user's personal storage space, is authorized to provide access to a trusted individual designated by the user and has means to do so. For sponsors (e.g., financial institutions), providing a context within which customers can manage their life transitions makes it likely they will benefit from the financial changes that result.

In addition to receiving, storing, and organizing information and documents from the user, certain embodiments of the invention allow for the receiving and storing of information and documents from other individuals such as a user's physician, accountant, lawyer, advisor, etc. In certain embodiments of the invention the system provides each user with a secure electronic mailbox to which documents and information can be sent. However, only the user can decide to include and store such information and/or documents in the user's secured storage space.

In certain embodiments of the invention the informational items and documents are organized as a set of folders, and informational items and documents submitted from diverse sources are automatically integrated across folders, so that information submitted from a particular source or in a particular document is available for appropriate inclusion in any of the folders. Of course a variety of other organizational approaches are also within the scope of the invention.

In certain embodiments of the invention some or all of the informational items and documents (both those submitted directly by the user and those submitted by others to the user's electronic mailbox) are submitted securely, e.g., in encrypted format. The system preferably provides a secure storage space, also referred to herein as a vault, to store some or all of the informational items. The storage space comprises a computer-readable medium. In addition, the system includes means for providing secure access to the stored items to the user, e.g., for review and update. In certain embodiments of the invention an RSA secure ID token (which may be embossed with the sponsor's name and which may be conveniently stored on a key chain) not only provides two-factor authentication, but also serves as the user's tangible key providing assurance of privacy and confidentiality. Authentication and access servers allow access to designated people on designated conditions such as death or incapacity.

### BRIEF DESCRIPTION OF THE DRAWING

FIG. 1 shows a networked computer system suitable for use with the present invention.

FIG. 2 shows a flow diagram of an interaction between a user and the Web site of the present invention.

FIG. 3 shows an example of the overall architecture of a user's personal legacy planning and storage space (referred to as an e-vault) in one embodiment of the invention. The figure also represents a schematic screen display that offers a user entry points into various folders in one embodiment of the invention.

FIG. 4 shows an example of a schematic screen display that offers a user entry points to information and documents stored in a personal folder.

FIG. 5 shows an example of a schematic screen display that offers a user entry points to information and documents stored in a medical folder.

FIG. 6 shows an example of a schematic screen display that offers a user entry points to information and documents stored in a legal, taxes, and insurance folder.

FIG. 7 shows an example of a schematic screen display that offers a user entry points to information and documents stored in a financial folder.

FIG. 8 shows an example of a display screen (Web page) that guides a user through the establishment of a personal legacy database, i.e., an electronic vault.

FIG. 9 shows an example of a display screen (Web page) that provides a full view of items that may be found in a user's personal folder and guides a user through the submission of such items.

FIG. 10 shows an example of a display screen (Web page) that provides a full view of items that may be found in a user's legal folder and guides the user through submission of such items.

FIG. 11 shows an example of a display screen (Web page) that helps a user cope with the transitions associated with a life event (death of a spouse).

### DETAILED DESCRIPTION OF CERTAIN PREFERRED EMBODIMENTS

I. Overview

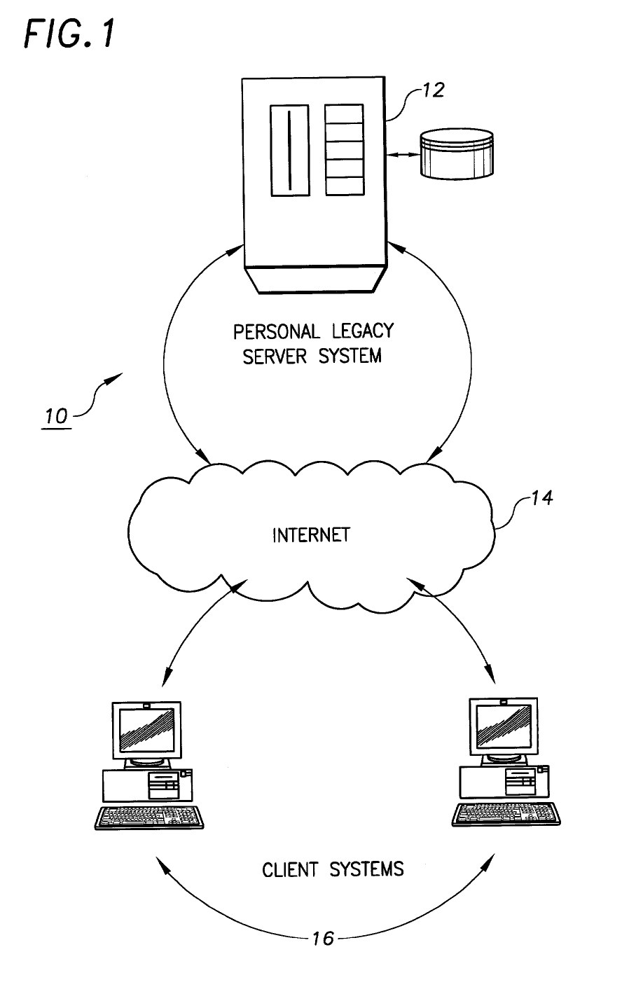

FIG. 1 shows a representative embodiment of a networked computer system 10 that may be used to implement the present invention. A server system 12 is logically connected, through a network such as Internet 14, to one or more client computer systems 16. Client computer system 16 can comprise any available computer but is typically a personal computer (e.g., a desktop, laptop, or notebook computer) equipped with a processor, memory, display, keyboard, mouse or other pointing device, storage devices, and appropriate interfaces for these components. Client computer systems 16 can optionally include peripheral devices such as printers and scanners (not shown). A client computer system 16 can also be a personal digital assistant (PDA), cellular phone equipped with equipped with appropriate networking capability, etc. Server system 12 can comprise one or more servers, optionally equipped with peripheral storage devices 18. Although only a single server is depicted, it is to be understood that multiple servers may be used in the implementation of the invention. Although, in general, the present invention can be implemented using any networked computer system, in the preferred embodiment described herein the invention is implemented using server and client computer systems that are connected to the Internet and are equipped, respectively, with server software and Web browser software. These elements are described in further detail below.

The invention assists a user in the development of a personal legacy plan that is stored on a computer-readable medium located at a secure central site removed from the user's own location. The invention includes computer software (i.e., computer-executable process steps stored on a computer-readable medium) that assist the user in the development of the plan, store information (preferably including documents) that form components of the plan, and provide access on a selective basis to the components of the plan. The invention thus provides a personal legacy and personal information organizer and storage space for a user. As used herein, the term “user” refers to an individual who utilizes the inventive system to develop a personal legacy plan. The term “personal legacy plan” is used broadly herein. A personal legacy plan may encompass documents and information that are traditional components of an estate plan but may also encompass a range of other documents and information that are not traditionally found in an estate plan. A personal legacy plan, as used herein, can include both informational fact-based data and also personal “items” that reflect an individual's personal, subjective experience. The informational, fact-based data may, for example, be stored in legal, medical, financial, and personal folders as further described below. The personal items may be described as the distillation of the important events and things in a person's life, e.g., events and things that one wants to preserve for one's children and for future generations. The personal items can include anything that can be digitized, e.g., journals, photos, videos, ethical will, letters, etc.

The storage space may include items of information stored in a database as well as documents uploaded by the user. The storage space need not be a single contiguous area of computer-readable medium but may include storage areas distributed throughout various storage devices (e.g., hard disks, etc.). However, in general, all items of information and/or documents submitted by a particular user are identifiable as originating from and pertaining to that user and are accessible only by that user and by a trusted representatives designated by that user upon the occurrence of a condition predetermined by the user (e.g., the user's death or incapacitation). As discussed further below, upon the occurrence of such a condition in preferred embodiments of the invention a trusted entity such as a financial institution provides such access, e.g., by releasing a second key (private key) to the storage space.

Turning again to FIG. 1, according to the invention, a user (i.e., an individual who wishes to use the invention to develop a personal legacy plan) accesses a Web site. Through interaction with the Web site, e.g., the transmission of Web pages 18 containing instructions and specific requests for appropriate information from the Web server to the user; entry of requested information into the Web pages by the user; submission of Web pages from the user's computer to the Web server; processing and storage of the submitted information by the Web server, etc., a personal legacy plan is developed. The invention may store the information in a personal legacy and personal information database 20. The information can be submitted by entering data into a Web form or by uploading documents.

The inventive system preferably organizes the information into various categories as described below so that the user and/or an individual such as an executor who accesses the information after the death of the user can readily locate any particular informational item. The user can change, augment, or update the personal legacy plan at any time simply by accessing the Web site, entering identifying information, and accessing the stored information. The inventive system offers the user options to change, augment, or update the information. Thus the present invention offers the advantage that personal legacy information can be accessed and changed at any time and from virtually any location from which the user can access the World Wide Web. In certain embodiments the invention also notifies the user upon the occurrence of events that may warrant updating of the personal legacy plan.

While the invention could be used as a tool to guide the user in the development of a personal legacy plan that would be stored in a traditional format (e.g., as paper documents in a safe deposit box or locked file cabinet), in preferred embodiments the invention provides additional capabilities. The secure storage space can be accessed by the user at any time from any computer equipped with an Internet connection and Web browser, functioning as an on-line safety deposit box. In addition, in preferred embodiments of the invention the system allows the user to select a trusted individual or individuals who can access the stored information upon a condition or condition(s) predetermined by the user, e.g., upon the death or incapacity of the user. For example, the user may select a trusted entity (e.g., a law firm, bank, financial intermediary, etc.) that provides access to the trusted individual(s) upon the occurrence of a condition predetermined by the user, such as the death or incapacitation of the user. The role of the trusted entity includes maintaining the user's list of designated representatives and the conditions under which access to the user's information and documents can be obtained. The trusted entity does not itself have access to the user's personal storage space but is empowered to grant access to the trusted individual, preferably after verifying both the occurrence of the predetermined condition and the identity of the trusted individual.

In certain preferred embodiments of the invention some of the documents and/or information such as medical records, financial records, tax returns, etc., may be provided by another party, herein referred to as a “contributor”. Such a party may be, for example, a professional such as a physician, accountant, etc. (or an employee of such a professional). In preferred embodiments of the invention, the system provides each user with an electronic mailbox to which contributors can send documents and/or information. However, only the user can move the information and/or documents into the user's storage space.

The following sections provide further description of important features of the invention. Since the preferred embodiment of the invention involves an implementation based on the Internet and the World Wide Web, these will be discussed first with reference to their use in conjunction with the invention. A server system typical of the invention in a preferred embodiment is discussed. The process by which a new user initially interacts with the Web site and the manner in which the invention assists the user in developing his or her personal legacy plan are described next, followed by a description of the process by which a returning user interacts with the system. The invention encompasses a variety of approaches by which information may be transmitted to the Web site, and these are detailed below. In addition, a user database that is a feature of preferred embodiments of the invention is presented. Embodiments of the invention in which a trusted entity can access the information as well as embodiments of the invention in which various types of feedback are provided to the user are described. Finally, security mechanisms that are an important feature of the invention are described. Unless otherwise specified, all patents, publications, references, etc., mentioned in this document are herein incorporated by reference. Unless defined otherwise herein, all technical terms are to be given their common meaning in the art, e.g., as defined in the Microsoft Computer Dictionary, 4^{th} Edition, Microsoft Press, Redmond, 1998, which is herein incorporated by reference.

II. Internet and World Wide Web

The Internet includes a large number of computers, computing devices such as PDAs, and computer networks that are connected through various communication links, over which they exchange information using such services as e-mail and the World Wide Web. The World Wide Web allows a server computer system (Web server or Web site) to transmit documents (i.e., Web pages) containing information to a remote client computer system, which can then display the Web pages. Both the server and client computers are provided with software to support World Wide Web interactions. Server systems run a Web server application program, i.e., a Web server engine. Client computers run a Web browser, i.e., an application program that facilitates the requesting and displaying of World Wide Web pages. Internet-linked computers and Web pages are uniquely identified by a Uniform Resource Locator (URL) and/or IP (Internet Protocol) addresses. To display a Web page, a client computer issues a request including the URL for that Web page. The request is typically a HyperText Transfer Protocol (HTTP) request. HTTP is a protocol (i.e., a formal set of conventions governing the formatting and relative timing of message exchange between two communicating systems) that is used for World Wide Web communication. The request is sent over the Internet to the Web server that maintains the Web page. Upon receipt of the request, the server sends the requested Web page to the client computer for display by the client's browser.

Web pages are generally written in a programming language called Hypertext Markup Language (HTML), which consists in large part of a set of tags that define the manner in which the material contained between matching pairs of tags is to be formatted and displayed on the screen. HTML provides for the display of text, graphics, images, etc. In essence, when a client computer sends a request specifying a particular URL, the server sends back an HTML file containing the code that defines the Web page. This HTML code is interpreted by the client's browser and displayed on the screen. A key feature of HTML and of the World Wide Web is that individual Web pages can be connected through elements known as links. When a user clicks on a link, which is typically represented by an image or highlighted word on the displayed Web page, the browser issues a request for a Web page specified in the link. The linked Web page is displayed on the client's screen. Thus links enable a user to conveniently navigate around the World Wide Web, moving from page to page within a Web site or from one Web site to another.

Originally HTML was generally limited to the display of static content on Web pages requested by the client. However, extensions to the language and the inclusion of programs (known as scripts) that can be run on either the client or the server side allow Web pages to behave in an interactive fashion, i.e., they provide the capability for response to user input. Form-based ordering systems (e.g., the on-line ordering system described in U.S. Pat. No. 5,960,411, “A Method and System for Placing a Purchase Order Via a Communications Network”, depend on this interactivity. In such systems, HTML elements such as check boxes, buttons, drop-down menus, etc., boxes, etc. allow users to indicate selections from a set of options presented on a Web page or enter text into designated fields. Web pages designed to accept user input typically contain a button (often referred to as a “submit” button) that the user clicks after entering data. Following submission, the data can be processed by a script.

Scripts can execute a variety of actions in response to user input including, for example, the return of user-specified data retrieved from databases accessed by the server or the storage of user-provided information into server-side databases. Scripts can be written in a variety of languages (e.g., JavaScript™, CGI/Perl). Microsoft's® Active Server Pages is an application environment that facilitates the combining of HTML, scripts, and other components to allow creation of dynamic (non-static) Web pages. Methods for creating and processing Web-based forms, including the use of scripts, are well known in the art, and specific implementation may be performed using any of a variety of approaches. See for example, Lemay, L. and Tyler, D., Sams Teach Yourself Web Publishing with HTML 4 in 21 Days, Professional Reference Edition, Second Edition, Macmillan, Inc., Indianapolis, 1999.

As mentioned above, HTML is a markup language. HTML is actually a subset of SGML (standardized general markup language). Other subsets of SGML such as XML (extensible markup language) are coming into increasingly wide use for writing Web pages. Although in preferred embodiments of the invention Web pages are written using HTML, the invention also encompasses the use of Web pages authored in different markup languages including those that currently exist and those that may be developed in the future.

III. Personal Legacy Planning Server

The personal legacy planning system of the present invention includes a server that acts as a central site for the reception and storage of personal legacy information, among other activities. As used herein, the term “server” is intended to include a single server, multiple servers, and accessory data storage devices accessible by such server(s). In a preferred embodiment of the invention the server is a World Wide Web server connected to the Internet and equipped with server software, referred to herein as a server engine. For example, the server may include a Web server running the Microsoft® Internet Information Server (IIS) software under Microsoft's NT® operating system. However, the server can employ any of a number of technologies commonly used in Web server development, for example Apache HTTP Server software running under the Unix, Linux, or other operating systems. The server preferably communicates over the Internet with a plurality of remote computing devices, including PCs, PDAs, etc., from which legacy planning and other personal information may be entered and/or viewed. Note that the server need not be dedicated solely to functions associated with the present invention. For example, certain embodiments of the invention comprise a Web site that may be provided through a Web hosting company, which may host multiple Web sites on it server(s).

IV. Interaction with Web site for a New User

This section describes an initial user interaction with the Web site of the invention in one embodiment of the invention. It is to be understood that the details of the user interface will vary according to the particular implementation, and therefore this description is for exemplary purposes and is not intended to be limiting. Instead, it is intended to describe the general areas of functionality of the inventive system. As described above, the user interactions typically take place via the transmission of Web pages from the Web site to the user and the submission of Web pages (e.g., forms) from the user to the Web site. In general, a user who wishes to utilize the inventive personal legacy planning service will access the Web site via a Web browser installed on his or her personal computer, PDA, etc. The Web browser can comprise any available Web browser, e.g., Netscape Navigator® or Microsoft Internet Explorer®, preferably a Web browser that supports SSL encryption. Throughout this document the invention is described with reference to a personal legacy planning and storage space for a single user. However, it is to be understood that multiple individual users can each have his or her individual personal legacy planning and storage space. In addition, in certain embodiments of the invention two or perhaps even more individuals can share part or all of a single personal legacy planning and storage space. This is particularly likely in the case, for example, of a husband and wife, since many possessions may be jointly owned, many documents may list both individuals, etc. Other examples would be an adult child helping to organize affairs for an elderly parent or relative.

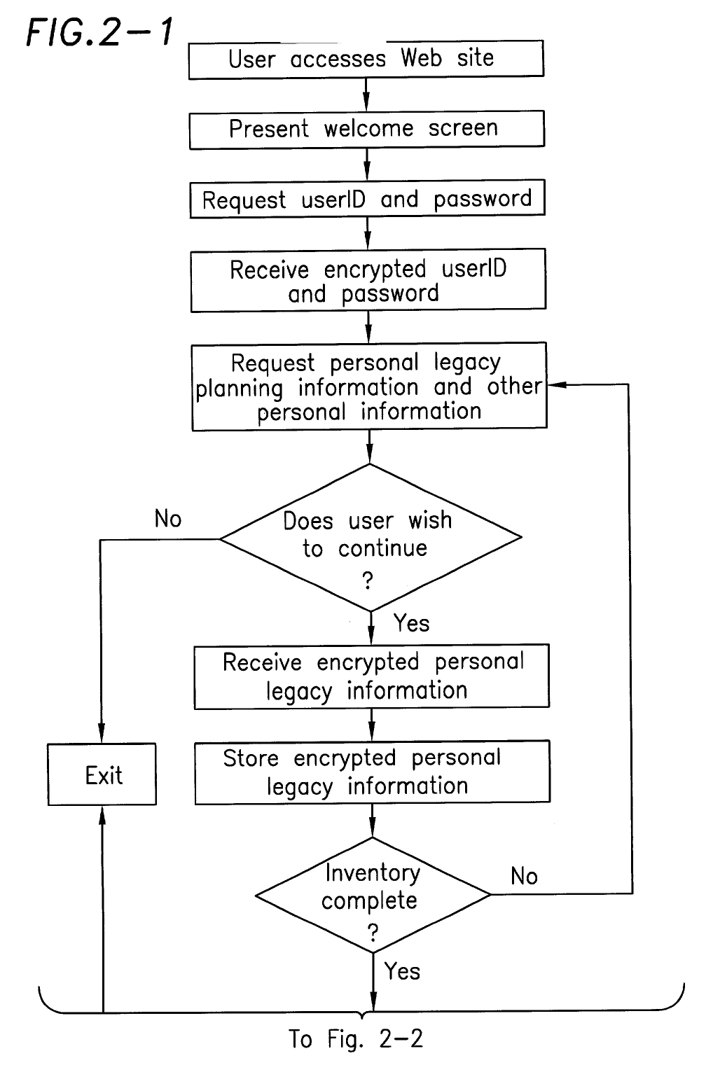

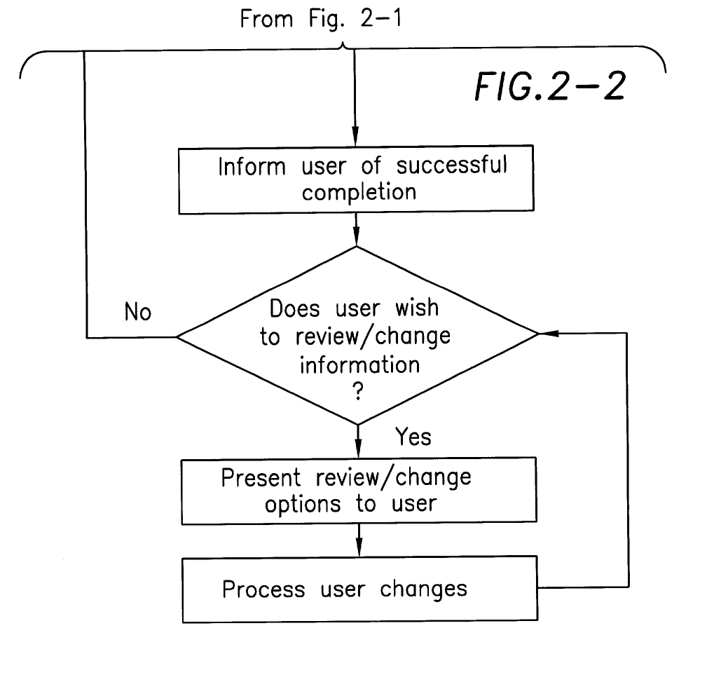

FIG. 2 shows a flow diagram of an initial interaction between a user and the inventive system in one embodiment of the invention, from the point of view of the system. To begin, in step 200 a user accesses the Web site. In step 205 the Web site presents a welcome screen or screens that may provide introductory information about the service and may allow a user to indicate that he or she is a new user. In step 210 the Web site requests the user to select a userID and password, e.g., by typing into fields of a form. In step 215 the Web site receives an encrypted userID and password. (As described below, information submitted by the user is preferably encrypted prior to transmission.) While a userID and password represent one potential security measure, the invention also encompasses the use of other measures such as a personal identification number (PIN), “smart card”, biometric token, or the like. Other means of identification and authentication include the use of “smart cards” or biometric samples, both of which are well known in the art. Methods for making smart cards are described in U.S. Pat. No. 5,955,021 and references therein. A typical method for using smart cards is described in U.S. Pat. No. 5,983,273, and biometric samples (also known as biometric token) are described in U.S. Pat. No. 5,870,723.

During the next phase of operation, in step 220 the Web site requests the user to enter items of information that constitute essential or desirable elements of a personal legacy plan. At decision point 225, if the user wishes to continue the user submits requested personal legacy plan informational items. If the user does not wish to continue, then in step 265 the user exits from the Web site. If, on the other hand, the user wishes to proceed with information entry, then in steps 230 the user submits requested informational which is transmitted to the Web server and stored in step 235. The information can be stored either on a secure server or securely on a peripheral storage device associated therewith. Preferably the information is stored in encrypted form. In step 240 the system determines whether a complete inventory of personal legacy planning information (described below) has been submitted. If so, then in step 245 the system notifies the user that the personal legacy plan is complete. If not, then processing returns to step 220, in which the system requests additional information from the user. In general, steps 220 through 240 are repeated sequentially until the user has entered all requested information or wishes to discontinue entering information. As the user enters information, the system preferably presents the user with a checklist of information entered and provides the user with indications of his or her progress towards completing the inventory. The system allows the user to enter relevant information either directly or through the uploading of documents previously stored in digital format, e.g., on the user's computer. Following entry of information at decision point 250 the user can choose to review or change the information. If the user does not wish to review or change the information then in step 265 the user exits from the Web site. If the user does wish to review or change the information then in step 255 the user is presented with review/change options that allow the user to view information and/or documents previously submitted to the Web site and to change, delete, or replace any of the information. In step 260, the system processes any user changes. Of course variations on the above sequence are within the scope of the invention, and the above description has been for illustrative purposes only, to describe the overall operation of the invention, and is not intended to be limiting. In general, the user can freely navigate between various pages of the Web site. In preferred embodiments of the invention the user may review or change previously entered information at any time.

Relevant information for a personal legacy plan falls into a number of categories. In general, the user is first prompted to enter basic personal information such as that outlined below.

A. Basic Personal Information

(1) Personal data: full name, home address, telephone number(s), social security number, birth date, and e-mail address.

(2) Relatives and other important individuals:

(i) Spouse: full name, social security number, birth date, e-mail address, date of marriage, any special needs, other information such as telephone number(s), home address, etc., if different from above

(ii) Children: full names, social security numbers, birth dates, college accounts, Uniform Gifts to Minors (UGMA) accounts, any special needs, other information such as telephone number(s), home address, etc., if different from above

(iii) Other dependents: e.g., parents, other relatives

(3) Key professionals

(i) Physician: name, telephone number(s), address

(ii) Attorney: name, telephone number(s), address

(iii) Accountant/financial advisor: name, telephone number(s), address

(iv) Named executor/next of kin: name, telephone number(s), address

(4) Individual/Institution Authorized to Access Records: name, telephone number, address, circumstances under which access authorized

(5) Funeral Information

Funeral/final disposition wishes

Prepaid funeral arrangement: with whom, location of contract

Burial plot: location

Individuals to contact

A major goal of the invention is to provide a flexible and user-friendly method for assembling information for personal legacy planning. To this end, the above information may be solicited through a series of forms that ask certain basic questions before proceeding to more specific questions. For example, a form may simply ask the user whether he/she has children. If this question is answered in the negative, then information about names, birth dates, etc., of children will not be requested. If the question is answered in the affirmative, relevant information will be requested. Certain items of information (e.g., telephone numbers) will fit into fields of a predetermined size while others (e.g., special needs of children) will require entry of substantially larger amounts of free text. The invention preferably accommodates entry of informational items of varying lengths. Information submitted by the user may be entered into appropriate fields of a user database, which is described in a subsequent section.

After entry of the basic personal information the system may request information that falls into the various categories described below.

B. Legal Records

(1) Attorneys: names, telephone numbers, addresses

(2) Documents:

Has user executed a will? Location.

Has user executed a durable power of attorney? Location.

Has user written a letter/instructions to executor? Location.

Does user have a nuptial agreement? Location.

Does user have business agreements, partnerships? Location.

(3) Titles: Does user possess titles to car, boat, etc.? Location.

(4) Real Estate:

Primary residence: address, location of title deed

Other real estate 1: address, location of title deed

Other real estate 2: address, location of title deed

Etc.

C. Financial Records

(1) Investment advisor/Broker/Financial planner: names, addresses, telephone numbers

(2) Assets

(i) Checking accounts: name of bank, account number, title to account

(ii) Savings accounts: name of bank, account number, title to account

(iii) Safe deposit boxes: name of bank, location of key

(iv) Securities (stocks and bonds): company/institution, number/amount, location

(v) S corporation stock: name of corporation, number/amount, location

(vi) Investment accounts: institution, title to account, password, location of records

(vii) IRA and Roth IRA accounts: institution, title to account, beneficiary for each, location of records

(viii) Retirement accounts (e.g., 401(k), profit sharing plans, pension plans): institution, title to account, beneficiary for each, location of records

(ix) Pension plan/Employer death benefits: institution, location of records

(x) Annuities: institution, title to account, beneficiary for each, location of records

(xi) Online accounts: URL, password

(xii) Copyrights/Patents: number, location of records

(xiii) Interests in trusts

(xiv) Expected inheritance: amount

(3) Liabilities

(i) Debt records

(ii) Active credit cards: institution, account number, PIN

(iii) Mortgages: lender, outstanding amount, location of agreement document

(iv) Guarantees: with whom, outstanding amount, location of agreement document

D. Tax Records

(1) Tax preparer/Accountant: names, addresses, telephone numbers

(2) Tax returns: Federal/state, years, location of records

(3) Gift tax returns: Location of records

(4) Estate tax returns of parent/spouse, etc.: Location of records

E. Insurance Policies

(1) Life Insurance: company, policy number, face amount, location of policy

(2) Medical Insurance: company, policy number, location of policy

(3) Mortgage or Loan Insurance: company, policy number, location of policy

(4) Accident Insurance: company, policy number, location of policy

(5) Auto Insurance: company, policy number, location of policy

(6) Credit Card Insurance: company, policy number, location of policy

(7) Property Insurance: company, policy number, location of policy

(8) Long Term Care Insurance: company, policy number, location of policy

(9) Medicare Insurance: company, policy number, location of policy

F. Health/Medical Records

(1) Physicians: names, addresses, phone numbers

(i) Primary care

(ii) Consulting

(iii) Dentist

(iv) Other

(2) Health Directives

(i) Durable power of attorney for health care: Location

(ii) Living will/Do not resuscitate instructions: Location

(iii) Physician directives: Location

(3) Documents

(i) Organ donor card: Location

(ii) Medical insurance: company, policy number, location of policy

(iii) Long Term Care Insurance: company, policy number, location of policy

G. Employment History

(1) Current employer: name, address, telephone number, human resources department phone number

(2) Prior employers: name, address, telephone number, pension plans/death benefits

H. Security

(1) Computer files: passwords, special instructions

(2) Security PIN numbers

(i) Bank

(ii) Credit cards

(iii) Combination lock numbers

(3) Keys: Location of keys to home, car, safe deposit box, files, others

(4) Confidential files: instructions regarding disposition of diaries, journals, etc.

I. Certificates and other records

(1) Birth: Location

(2) Marriage: Location

(3) Divorce: Location

(4) Adoption: Location

(5) Citizenship: Location

(6) Passport: Location

(7) Social security card: Location

(8) Military service and discharge records: Location

J. Personal Items

(1) Resume/CV: Location

(2) Memberships in union, professional organization, etc.: Organization, address, phone number, location of membership cards/records

(3) Diplomas, honors, awards: Details, location

(4) Family tree/genogram: Location

(5) Oral history: Location of tapes, videos, etc.

(6) Other items for heirs

(i) Photos: Location

(ii) Location of heirlooms

A more extensive listing of the categories of relevant information and documents is found in Section XII.

Note that some of the requested information may duplicate information requested earlier in the information gathering process. In such a case the system automatically displays the previously entered information and allows the user to augment it. For example, if the user entered an attorney name while entering Basic Personal Information, then when the user progresses to the Legal Records section this attorney name is automatically displayed and entered into the database so that the user does not need to duplicate effort. However, the user may add additional attorney names.

In certain preferred embodiments of the invention the user is offered the opportunity to request additional information about various items and/or instructions about how to complete an item. For example, the user may wish to learn more about what constitutes a living will or may wish to learn why a particular item of information is being requested. The system preferably provides Web pages containing such information and may optionally offer links to other Web sites containing relevant information.

In addition, in certain embodiments of the invention the user is offered the opportunity to create a document such as a family tree or a summary health-at a glance card. Information required for such documents can be gathered using the same form-based approach described above. The completed document can be downloaded, printed, etc., just as for any other document stored by the user (see discussion below). The invention also encompasses the use of digital signature technology for the signature of electronic documents. Such technology may be particularly useful, for example, to validate instructions such as physician directives.

Gathering the information detailed above may require a considerable amount of time. In addition, it is likely that a user may need to consult records, phone books, etc., to locate some of the information and may not have some of the requested documents readily available. Thus in preferred embodiments of the invention the user can exit the Web site at any time. The system saves the data entered thus far and, when the user next accesses the Web site, he or she can continue adding information at the point at which the previous session terminated.

As described further below, in certain embodiments of the invention the service is offered through an institution, e.g., a financial institution such as a bank or an accounting firm. In this case the user may be provided with the option to designate that certain of the information, e.g., asset information, is to be added by the institution offering the service.

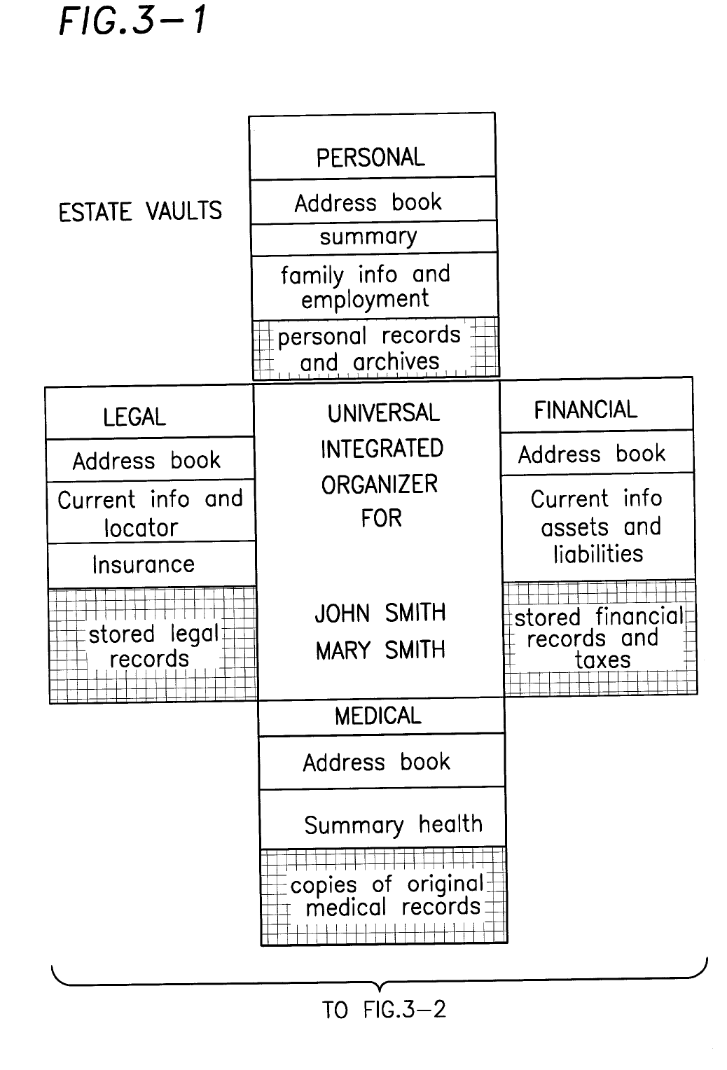

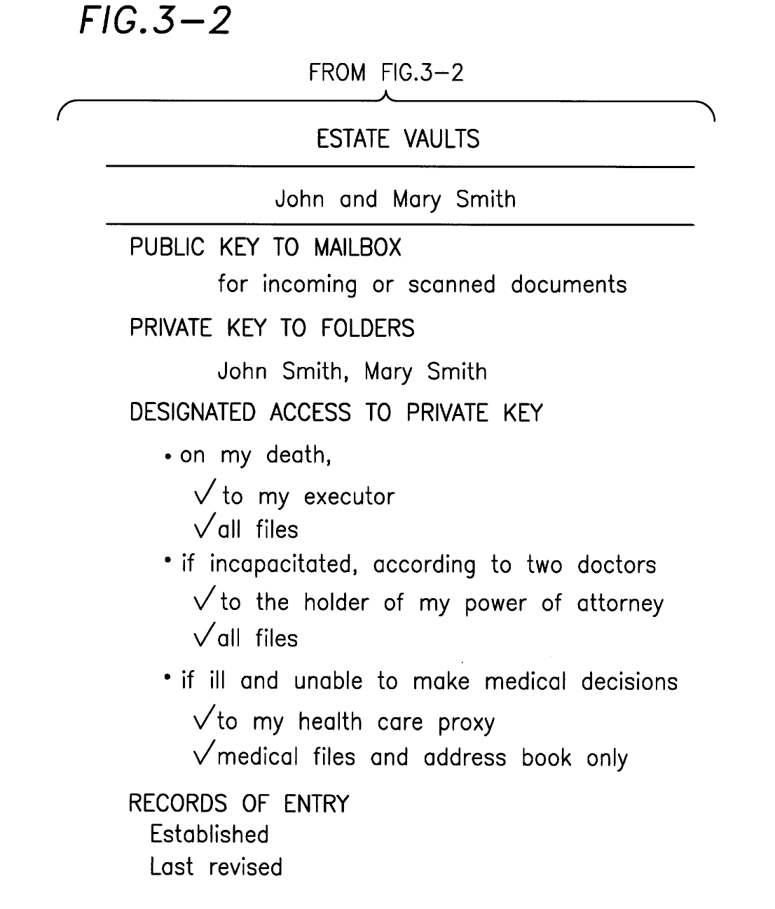

FIG. 3 shows a schematic view of the way in which the inventive system organizes the provided information in a preferred embodiment of the invention. In a preferred embodiment of the invention this organizational outline is presented as a screen to a new or returning user, in this case John or Mary Smith. The various labels on the figure (e.g., major labels such as personal, legal, financial, medical, and the labels beneath these major labels) represent links (see description above of links). When the user “clicks” on the link the corresponding information or document, and/or forms in which the information can be entered or changed, is presented to the user.

As also indicated on FIG. 3, in certain embodiments of the invention each user's personal storage space (e-vault) is associated with a public key, which can be used to encrypt incoming information, including documents sent to the user's electronic mailbox by contributors. Thus information or scanned documents to be submitted to John and Mary Smith's e-vault or electronic mailbox will be encrypted using their public key. In these embodiments each e-vault is also associated with a private key, known only to the user, which can be used to decrypt information and documents encrypted with the corresponding public key. Thus John and Mary Smith can use the private key to access the information and documents in the folders and storage. In addition, in the example presented in FIG. 3, John and Mary Smith have entered information designating trusted individual(s) to whom the private key is to be provided upon the occurrence of certain conditions. The Smiths have also entered information indicating the particular conditions under which the private key is to be provided to the trusted individual(s). According to preferred embodiments of the invention, an entity such as a financial intermediary maintains a list of these individuals and the designated condition(s) and provides the private key to the trusted individual(s) upon occurrence of the condition(s). In addition, the screen shown in FIG. 3 displays dates when the records were established and last revised.

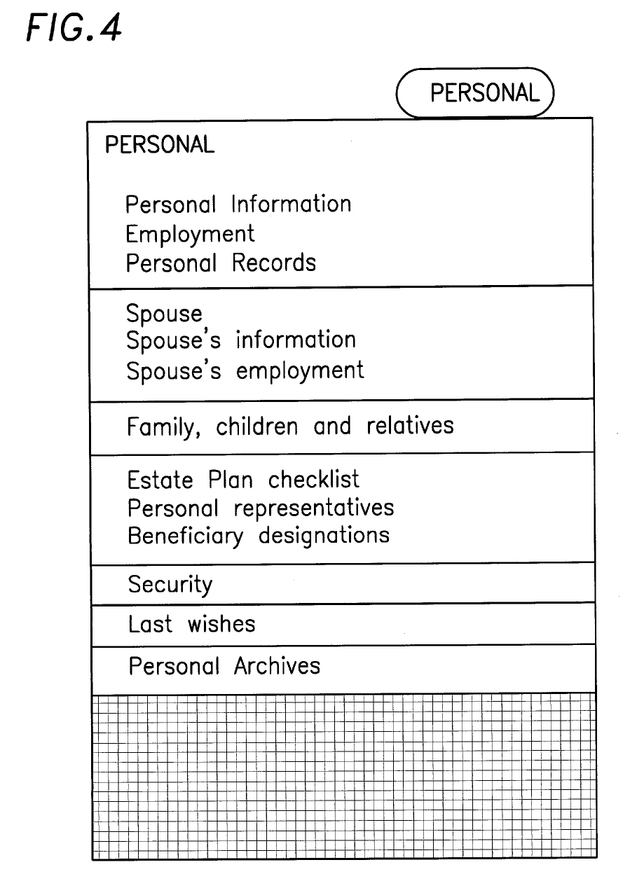

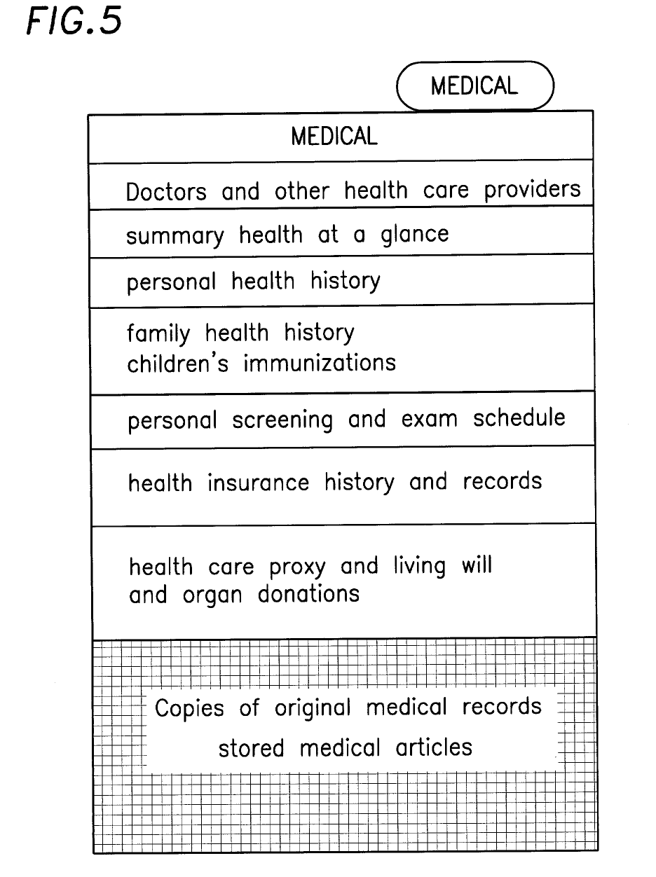

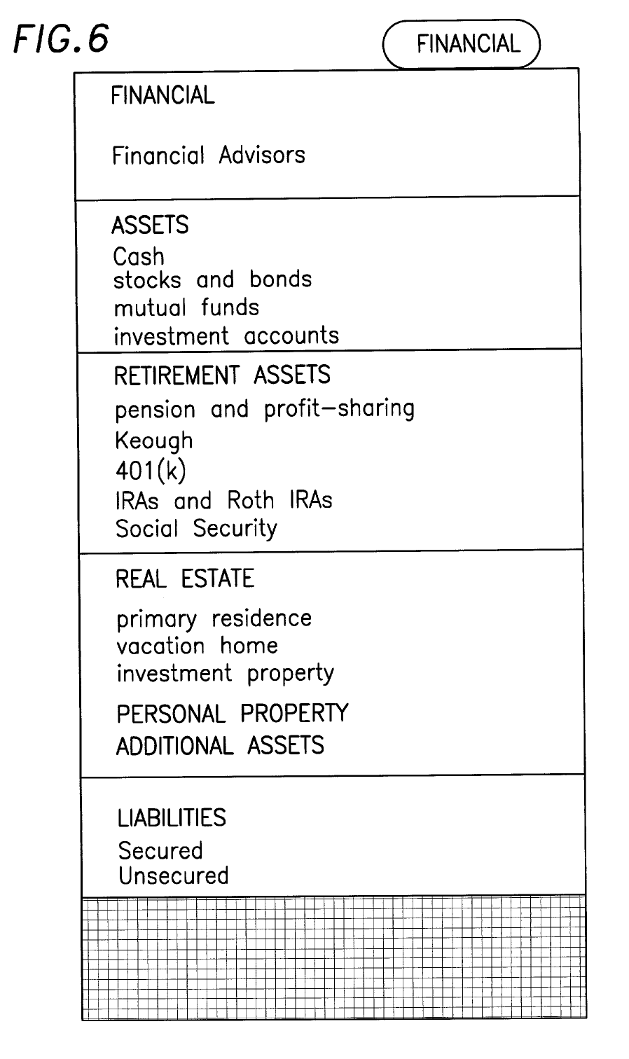

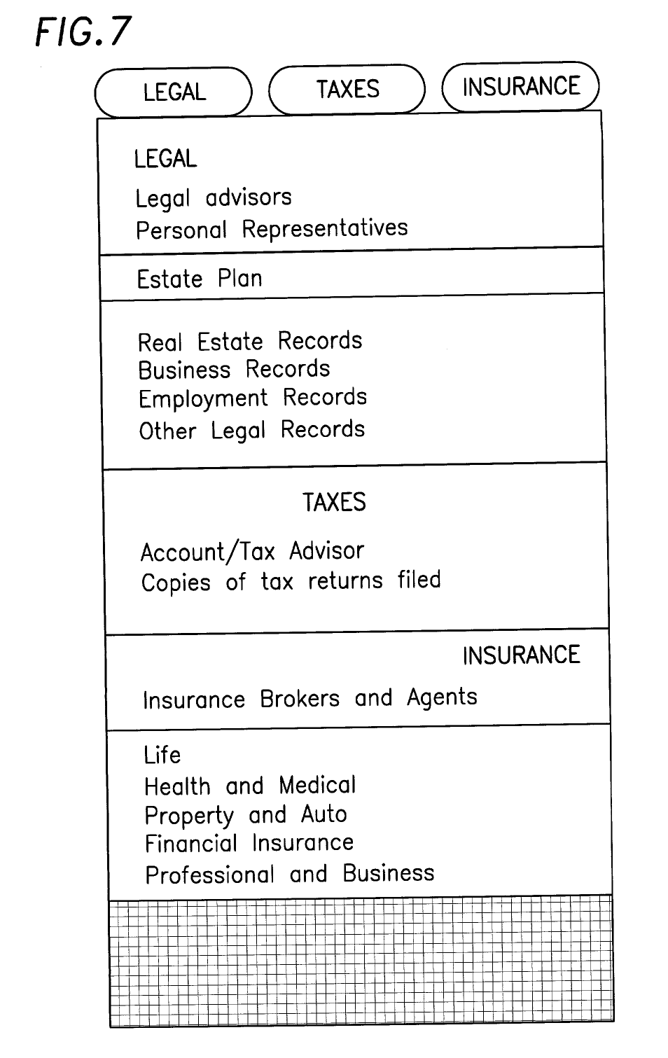

FIGS. 4-7 present examples of screens that the user would see upon clicking on the personal, legal, financial, or medical links on FIG. 3. Section XII presents the architecture of the various folders and their integration in one embodiment of the invention in greater detail. As indicated in Section XII, the folders preferably contain information organized in a hierarchical fashion, and the software includes the capability to generate a variety of useful summaries based on the information contained in the folders. As indicated in Section XII, certain information is indexed across folders. For example, the Personal Representatives and Advisors-Key Professionals sections under the Personal Folder, also appear in the Medical Folder, Financial Folder, and Legal Folder (and subfolders thereof) in their appropriate positions. Although these Figures and Section XII provide details of specific embodiments of the invention, it is to be understood that any particular implementation of the invention need not contain all the items indicated in the Figures or the elsewhere and may contain additional items.

As described above, the invention takes an active role in gathering information from the user in an effort to assist with the development of a comprehensive legacy plan. However, it is not a requirement that the invention actively solicit information from the user. In an alternative embodiment of the invention, during the initial (and subsequent) interactions with the Web site the user may simply be presented with a screen such as FIG. 3 and may select which of the categories of information he or she wishes to enter at any particular time.

V. Interaction with Web Site for a Returning User

As mentioned above, a user may require more than one session to enter his or her personal legacy information. Furthermore, once the initial information is entered the user may wish to change, update, or augment the information. After the initial interaction with the Web site, during which the user enters identifying information such as a userID and password, the user can gain access to his or her personal legacy information by accessing the Web site and entering the appropriate identifying information when prompted to do so. In certain preferred embodiments of the invention a “cookie” is stored in the user's Web browser, thus allowing the Web site to recognize a returning user. In such a case the user may not be required to enter a userID. However, in general, entry of a password will still be required given the importance of security to the invention.

In preferred embodiments of the invention the returning user is presented with a personalized screen such as that shown in FIG. 3. The user can then click on any of the links to view the corresponding information and documents. In preferred embodiments of the invention the returning user is presented with various options. Such options include resuming the information entry process, viewing previously entered information, changing previously entered information, and adding additional information. In preferred embodiments of the invention the information is organized into a convenient and readily viewable format. As described above, the information falls into various categories, e.g., medical records, legal records, financial records, etc. As shown in FIGS. 3-7, in preferred embodiments of the invention the information is organized into folders corresponding to the various types of information. In general, a wide variety of organizational and display approaches are within the scope of the invention. Organization is discussed further below.

VI. Transferring Information to the Web Site

Selection of the most appropriate means for transferring information to the Web site for storage depends, in general, upon the nature of the information and the extent to which the information already exists in the form of paper documents or documents stored on a computer-readable medium. As described above, in preferred embodiments of the invention, certain of the information is entered through a user's interaction with the system using a form-based approach. For example, in preferred embodiments of the invention forms requesting the entry of basic information such as some or all of the personal information listed above are filled out and submitted by the user during an initial interaction with the system. The system allows the user to view, update, and/or change any of the information entered via a form.

While forms provide a convenient means by which a user can enter information, such information can also be provided using a variety of alternative approaches. For example, a user may already have undertaken a certain amount of estate planning activity and may have organized some of the information on paper. In general, documents such as wills, insurance policies, deeds, etc., already exist in a paper format. Traditional estate planning has involved the storage of such documents in a safety deposit box or in a secure storage location such as a locked filing cabinet, safe, etc. The present invention encompasses the storage of such documents in digital format on a server computer associated with the Web site or on a peripheral storage device. Such documents can be scanned into a user's computer using any commercially available scanning device and associated software. Once converted into digital format using any available technique, not limited to those previously described, a document can be uploaded, i.e., transmitted to the Web site of the present invention.

Documents can also be created using word processing software, image processing software, etc. A user may, for example, employ a computer program that aids in preparation of tax returns (e.g., Quicken TurboTax®) and submit the electronic document created thereby directly to the inventive Web site. To this end, the software of the invention is preferably compatible with various commercially available software applications such as Quicken.

As described further below, documents prepared by an independent party such as an accountant, etc., can be sent to the user's personal legacy storage mailbox for the user to move into his or her personal storage space if he or she so desires. Information such as medical records, etc., can also be similarly submitted by independent parties such as hospitals. In preferred embodiments of the invention the system notifies the user (e.g., by e-mail) whenever an informational item or document has been submitted to his or her personal legacy storage mailbox. Thus the user can transfer the information or document to his or her vault in a timely fashion.

Preferably all information is encrypted prior to transmission. With the increasing use of the Internet and the World Wide Web, it is anticipated that an increasing proportion of the documents relevant to personal legacy planning will be created using Web-based software tools and/or be available through the World Wide Web. The invention encompasses the direct submission of such documents to a user's personal legacy storage mailbox, from which it can be transferred by the user to his or her personal legacy storage space. To this end the invention is preferably able to handle and interpret data submitted in a variety of formats such as HTML, XML, OFX, QIF, and custom formats.

As mentioned above, the invention envisions submission of some of the documents by uploading scanned images. In preferred embodiments of the invention documents can also be faxed electronically. In preferred embodiments of the invention certain documents (e.g., wills, medical records and certain others that are likely to be provided as scanned or faxed optical images) are maintained in a “read only” state in which they cannot be changed or modified. In order to revise such documents a new, more recently dated version may be submitted.

During the information entry process described above, in preferred embodiments of the invention the user is offered the choice of entering information directly into forms or of uploading documents that contain the indicated information. As indicated above, the system requests the location of many documents that contain information relevant to the estate plan. In the case in which a document is uploaded, the user has the option of specifying that the document has been uploaded to the Web server rather than specifying the location of a hard copy version of the document. In certain preferred embodiments of the invention an electronic log of user interaction with the Web site is maintained, and the time and date of submission of information is stored in addition to the information itself. Thus the functioning of the personal storage space parallels that of a traditional safety deposit box in which a record of entries to the safety deposit box is kept.

VII. User Database

In certain embodiments of the invention information submitted by users is stored in one or more databases, which may be implemented in a variety of ways. For example, some of the data may be stored in a relational database referred to as the personal legacy information database, containing multiple data tables. In certain embodiments of the invention the database uses Structured Query Language (SQL). SQL allows users to define, access, and manipulate data in a wide range of relational database management systems, such as Oracle, Sybase, Informix, Microsoft Access, and others. It should be understood that the data may be stored in separate databases, including databases accessible over a data communications network, and that other types of databases (e.g., object-oriented databases) could be used in the invention. However, for purposes of description it will be assumed that the data are stored in a relational database in multiple tables.

Thus in certain embodiments of the invention the personal legacy information database is an SQL database consisting of a set of tables, each of which consists of multiple records containing fields in which data is stored. One field in each record (or a combination of fields) constitutes a key, i.e., an item (or items) of data that uniquely identifies that record. (Note that the term “key” is used here in a different sense to a private or public key for encryption/decryption purposes.) A suitable key is a user's social security number. The tables may include, but are not limited to: a basic personal information table, a legal records table, a financial records table, a tax records table, an insurance policy table, a health/medical records table, an employment history table, a security items table, a certificate/other records table, and a personal items table. Of course any convenient selection of tables and any approach to organization of the informational items is within the scope of the invention. The fields in each table correspond to information items. For example, the basic personal information table may contain fields such as: name, address, telephone number, social security number, etc. In preferred embodiments of the invention the tables will also contain standard fields such as creation time stamp, update time stamp, archive time stamp, and various status flags. In the case of documents that are uploaded by the user and stored by the inventive system, instead of containing the documents themselves the tables preferably contain information that allows the stored documents to be identified and accessed (e.g., an address location, storage location, etc.).

VIII. Providing Feedback to the User

While the contents and complexity of an estate plan may vary depending upon the estate, one of the goals of the present invention is to ensure that the estate plan includes at least a minimum of essential information. This goal may be achieved, in part, by explicitly requesting the submission of certain information as described above. In certain preferred embodiments of the invention as the user completes various information requests the system provides feedback to the user. Such feedback may be positive, e.g., a message congratulating the user on successfully entering requested information. In addition, the system can notify the user of omissions and identify those areas in which the user has not yet submitted sufficient information.

In certain preferred embodiments of the invention the user is notified (e.g., by email) upon the occurrence of events that may indicate that it is desirable to revise the personal legacy plan. Such notification can take place according to a predetermined schedule, e.g., annually. Notification can also occur upon changes in laws (e.g., tax laws, inheritance laws, etc.) that may have an impact on the user's decisions regarding the disposition of his or her estate. Notification can also occur upon significant changes in the personal legacy plan itself. For example, if a user purchases a home and submits a title deed to his or her personal legacy storage space, the system may notify the user that his or her will should be updated.

IX. Trusted Entity, Trusted Individual(s) and Access by Trusted Individual(s)

It is envisioned that in certain embodiments the invention will be offered as a service by an organization such as a bank or other financial institution, law firm, or the like. In these embodiments the invention may be offered as an option that a user can access through the Web site of the organization rather than, or in addition to, through a “stand-alone” Web site. In certain embodiments of the inventive system the user can designate one or more trusted individuals (e.g., an executor or next-of-kin) who is granted access to the personal legacy storage space under certain circumstances predetermined by the user. The user may be asked to enter the name, address, and phone number of the trusted individual during the process of entering personal legacy planning information. (See item A.4 in the list of information items presented above.) In addition, the user may be requested to enter the condition(s) under which the trusted individual is to be granted access (typically the death or incapacitation of the user). If such condition predetermined by the user occurs, the trusted individual identifies himself or herself to the organization and is granted access to the user's personal legacy storage space. Alternatively, the organization may contact the trusted individual. Since, in certain embodiments of the invention the user's personal legacy information is stored in encrypted form, such access will require decryption of the information. To this end, the trusted individual is in possession of the key (e.g., a private key) required to decrypt the user's personal legacy information. The organization provides the key to the trusted individual so that the information can be decrypted. In certain embodiments of the invention the organization verifies both that the circumstance (e.g., the death or incapacitation of the user) has occurred and also verifies the identity of the trusted individual (e.g., that the individual is truly the person so designated by the user). The trusted individual's identity may be verified in any of a variety of ways or combinations of ways. For example, the trusted individual may be required to present photo ID, a password, a biometric token, etc. While it is envisioned that in most instances the trusted individual designated by the user will be a person distinct from the sponsoring entity, in certain embodiments of the invention the sponsoring entity may possess the key used for decryption.

X. Security

The challenges of ensuring the security of information transmitted over a computer network such as the Internet and of ensuring the security of information stored on a computer or on a peripheral storage device are receiving increasing attention. With the growth of e-commerce and the storage of increasing amounts of personal information on computers has come a host of commercial products aimed at addressing this need. Given the sensitive nature of many of the documents associated with personal legacy planning, security forms an important component of the inventive system. An ideal computer and network security system should address the following six general areas:

(1) Confidentiality: Ensuring that information stored on and/or transmitted to a computer system are accessible only to authorized parties. Access includes printing, displaying, etc., as well as merely revealing the existence of the information.

(2) Authentication: Ensures that the origin or an electronic document or message is correctly identified and that the identity is not false.

(3) Integrity: Ensures that only authorized parties are able to modify (e.g., write, change, change status of, delete, create, delay, or replay) any transmitted messages or information.

(4) Nonrepudiation: Requires that neither the sender nor the receiver of a message be able to deny the transmission.

(5) Access control: Requires that access to information resources (e.g., lists of passwords) is controlled by the system

(6) Availability: Requires that information stored on the computer system be available to authorized parties when needed.

Computer and network security issues and approaches are discussed in Stallings, W., Cryptography and Network Security: Principles and Practice, Second Edition, Prentice-Hall, Upper Saddle River, 1999, the contents of which are herein incorporated by reference. Further information on specific aspects of computer security, including considerations particularly relevant to the Internet may be found in Maximum Security: A Hacker's Guide to Protecting Your Internet Site and Network, Second Edition, Macmillan, Inc., Indianapolis, 1998, the contents of which are herein incorporated by reference.

In preferred embodiments of the invention the Web site maintains appropriate security precautions that comply with prevailing standards for secure transmission of secret information (e.g., credit card numbers) over the Internet. In particular, in preferred embodiments the inventive system allows the user to select a secure transmission option in which a transmitted document is encrypted before transmission. In addition, identifying information such as passwords, personal identification numbers, etc. are encrypted in preferred embodiments of the invention. Encryption can be performed using any of a variety of techniques well known in the art. Conventional (i.e., symmetric) encryption can be used such as that embodied by the Data Encryption Standard (DES), adopted by the National Institute of Standards and Technology (NIST). Public key (i.e., asymmetric) encryption can also be used. For example, in certain embodiments of the invention information to be transmitted to the user's personal storage space is encrypted using the user's public key. Encryption with the user's public key allows both the user and contributors to securely submit documents and information relevant to that particular user. The information and documents can only be decrypted by an individual (e.g., the user) having access to the user's private key. Upon the occurrence of events specified by the user, e.g., the death or incapacitation of the user, the private key can be provided to one or more individuals preselected by the user. In certain embodiments of the invention, security is provided by a commercial provider such as RSA Security Inc. (http://www.rsa.com), 20 Crosby Drive, Bedford, Mass. 01730; Tel: 877-RSA-4900 or 781-301-5000. In certain embodiments of the invention a user is provided with an RSA secure ID token (which may be embossed with the sponsor's name and which may be conveniently stored on a key chain). The RSA token provides a new six-digit number every two minutes. When a user logs in to the Web site of the invention, the user undergoes two-factor identification. The user must provide something he or she knows (his/her password) and something that only he or she has (the number that is currently presented on the token). Such a token not only provides two-factor authentication, but also serves as the user's tangible key providing assurance of privacy and confidentiality.

In certain embodiments, the invention uses the state-of-the-art, industry-standard SSL (Secure Socket Layers) protocol to shield information during transmission. In addition, in preferred embodiments the invention only supports browsers that can use SSL encryption. Other commercially available technology such as that available through Verisign®, Mountain View, Calif. 94043 can be used in conjunction with the invention. Methods for electronic transmission, storage, and retrieval of authenticated documents are described in U.S. Pat. No. 5,748,738 issued May 5, 1998. Methods by which a sender can verify that a receiver has received a document containing particular content (non-repudiation) are described in U.S. Pat. No. 5,790,669, issued Aug. 4, 1998. The contents of the two preceding patents are incorporated herein by reference.

As mentioned above, in addition to encrypting the information during transmission to the Web site, in preferred embodiments of the invention the information is stored in an encrypted form. Additional security measures at the Web site include use of a firewall to prevent unauthorized access. In general, any commercially available firewall can be used. Physical access to the Web server and to any peripheral storage devices associated therewith is preferably restricted to trusted individuals. While challenging, the issues of secure transmission and storage of personal information are presently effectively addressed by a variety of approaches well known in the art.

XI. Organization, Integration, and Online Collaboration

A major feature of certain preferred embodiments of the invention is the capacity to organize and integrate information of diverse types and obtained from a diverse array of sources. For example, in the preferred embodiments of the invention in which the information and documents are organized as folders (FIG. 3), The invention is able, for example, to recognize when an item of information entered under one folder heading is also relevant to the contents of one or more of the other folders. For example, an individual's residential address in the Personal Folder may also be a real estate asset that may also be a secured liability in the Financial Folder with homeowners' insurance (Insurance Folder) and legal title (Legal Folder). The software of the invention integrates such information so that it is readily available across all folders. Thus in preferred embodiments of the invention, any information or document that is initially entered under a particular category in one of the folders is available in an appropriate category in one or more of the other folders.

In certain embodiments of the invention the design of the Web site and the types of resources and information available through the Web site reflect transitions of people's lives (e.g., marriage, birth of a child, career change, death of parent, death of spouse, etc.). Each life event involving a major change in a person's life may contain “maps of the territory”, guides and resources as well as checklists. Maps of the territory may include a list of questions that a person might commonly ask when a given life event occurs, and answers to these questions. Guides and resources may include recommendations of books or organizations that may be useful in helping the person understand and/or cope with the life event. Checklists may offer suggestions for appropriate actions a person might take when a particular life event occurs.

In addition, in certain embodiments of the invention the software operates in conjunction with any of a variety of on-screen aggregators (e.g., Yodlee.com), thus enabling the aggregation of personal information entered in numerous formats and from numerous sources. Information from dynamically changing sources such as financial accounts, etc., can therefore be seamlessly integrated into the personal legacy planner and storage space. In this regard it is noted that an ever-increasing number of institutions such as banks, credit card companies, etc., are providing users with access to their accounts on-line. In certain embodiments of the invention such information is integrated with the user's universal organizer.

In certain embodiments of the invention the Web site offers a forum for online collaboration between, for example, the user and his/her family members, professional advisors, etc. Any appropriate technology for online collaboration may be used.

XII. Examples of a Representative Embodiment

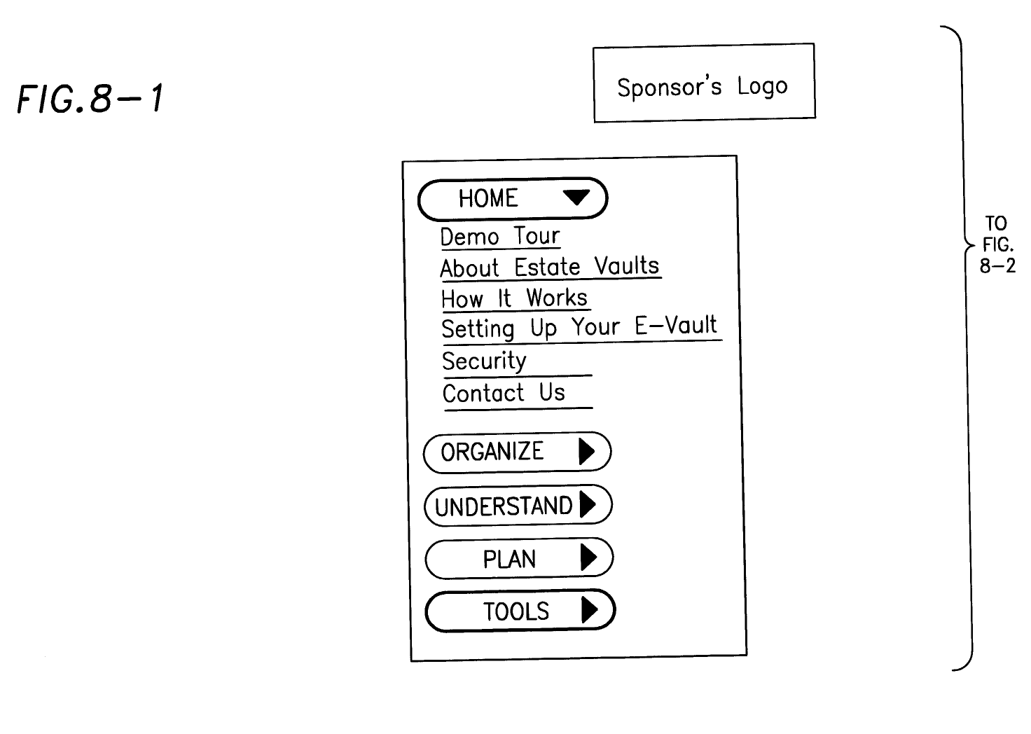

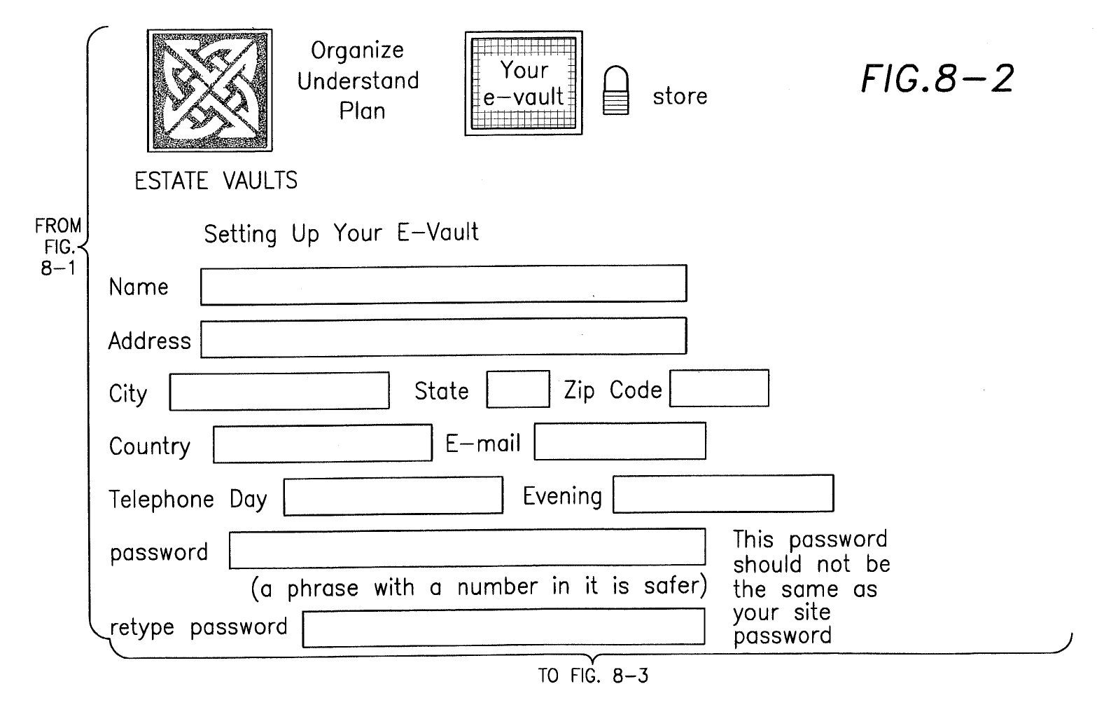

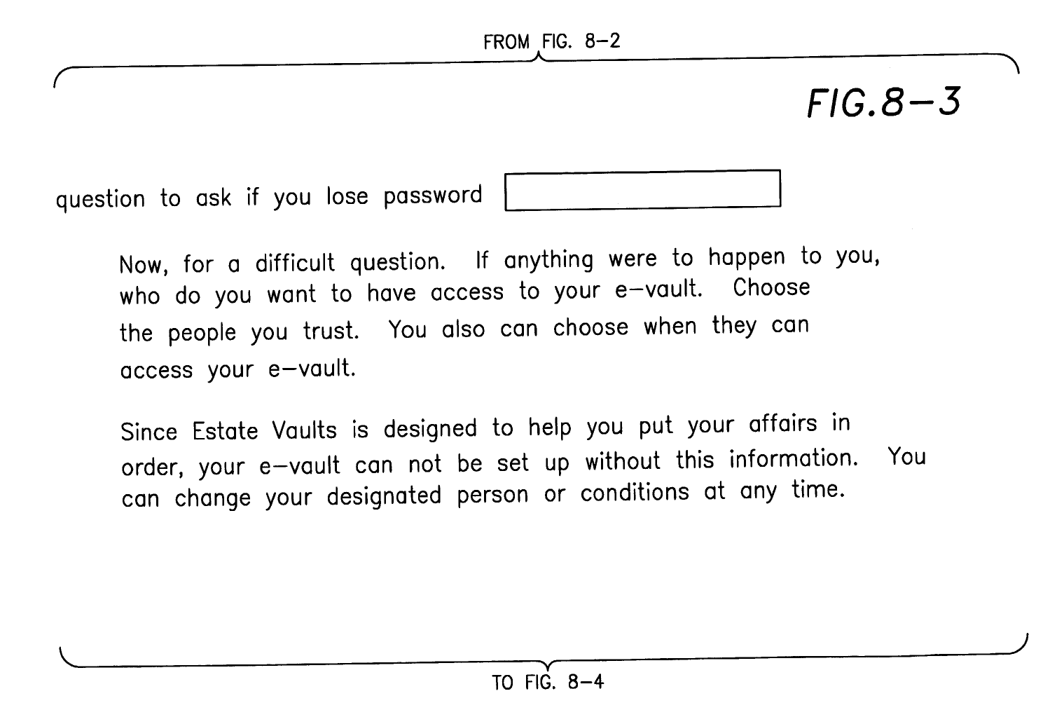

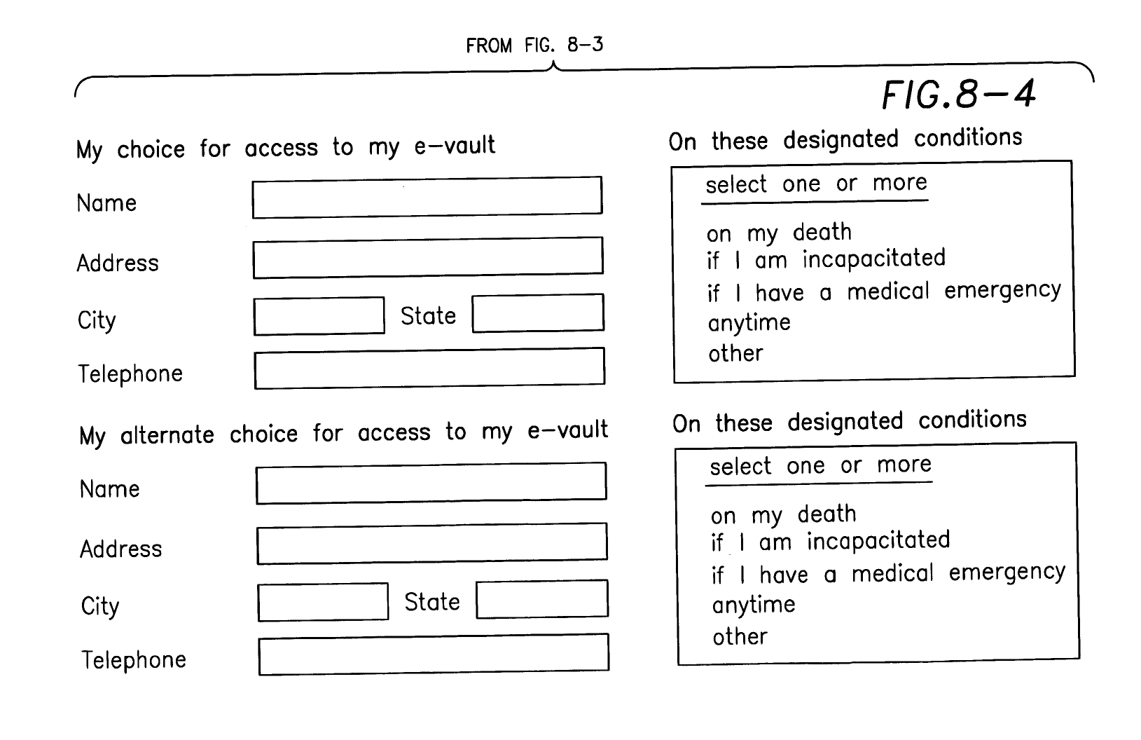

FIGS. 8-11 depict display screens that may be used in an exemplary implementation of the invention and provide a more comprehensive understanding of certain features of the invention. It is to be understood that these examples are not intended to be limiting in any way.

FIG. 8 shows an example of a display screen (Web page) that guides a user through the establishment of a personal legacy database, i.e., an electronic vault. The Web page gathers a small amount of personal information and requests that the user enter a password. In addition, the introductory Web page asks the user to select a trusted individual who will be empowered to access the information in the electronic vault upon the occurrence of a designated condition. The Web page also asks the user to select the predetermined condition.

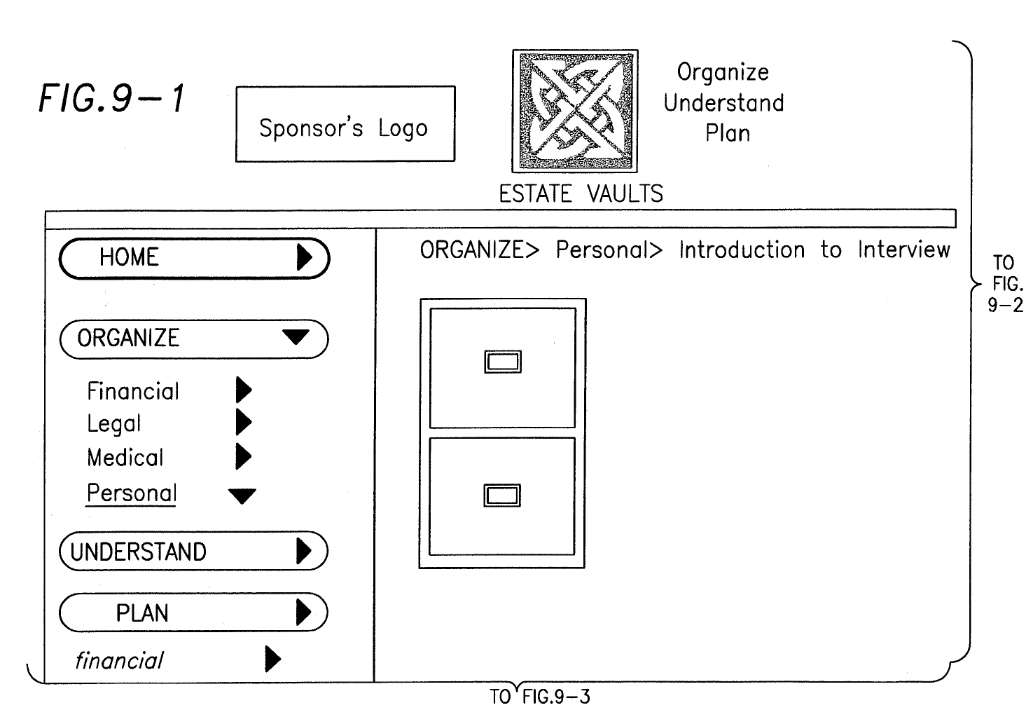

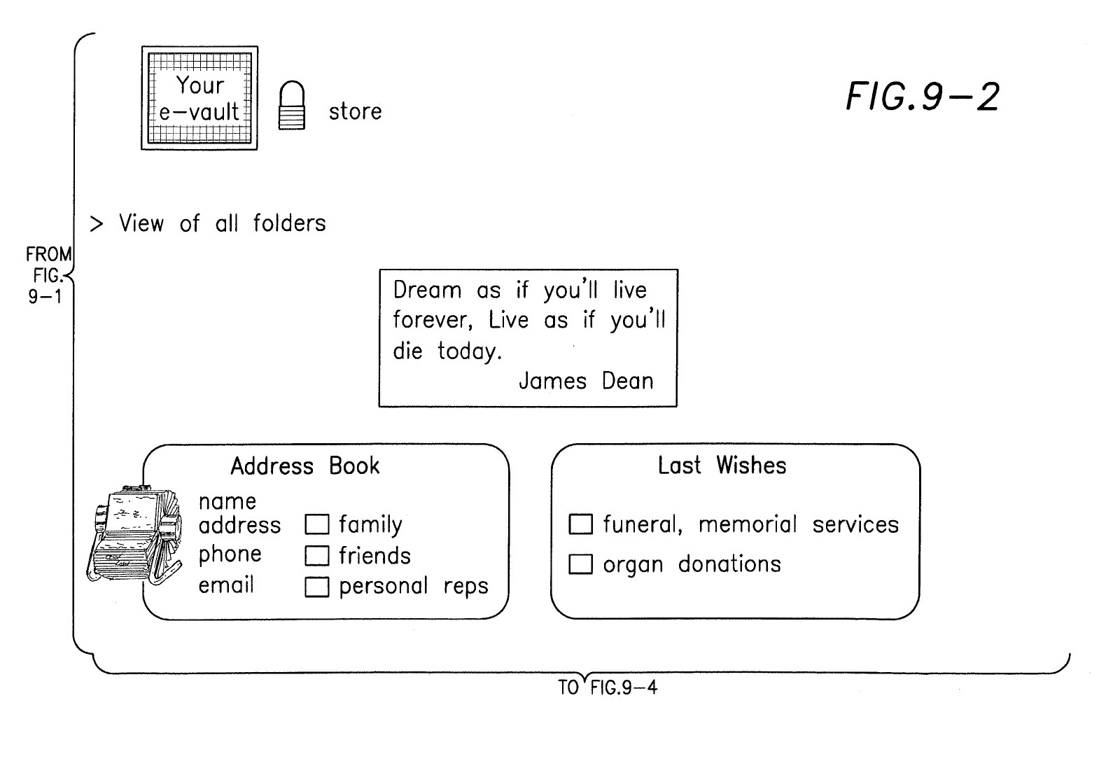

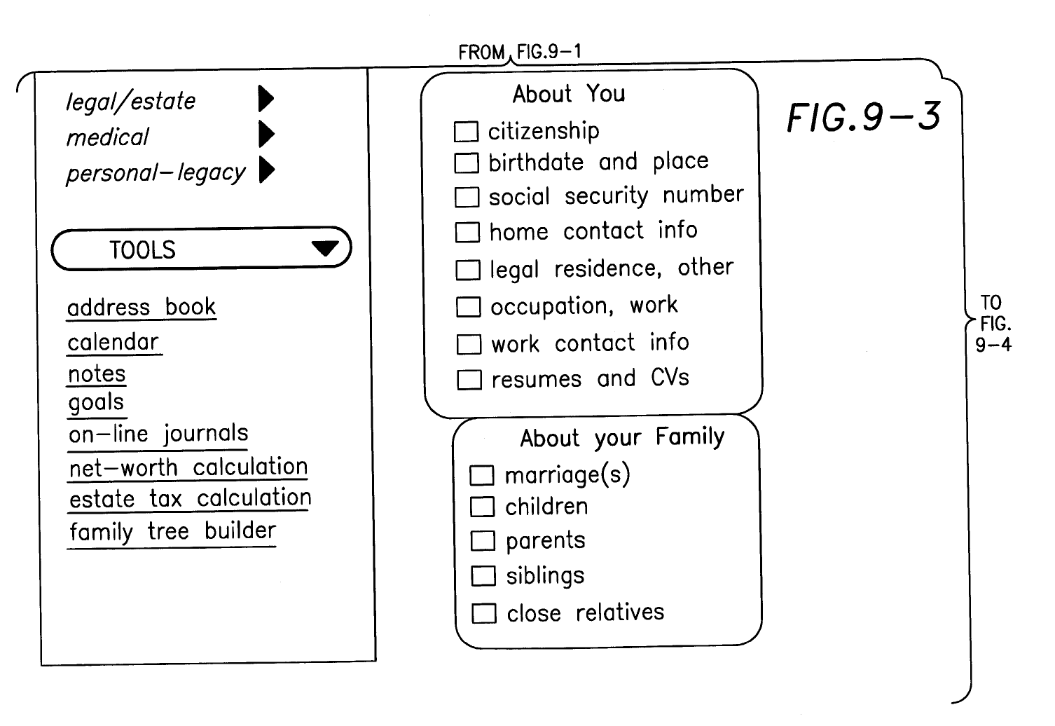

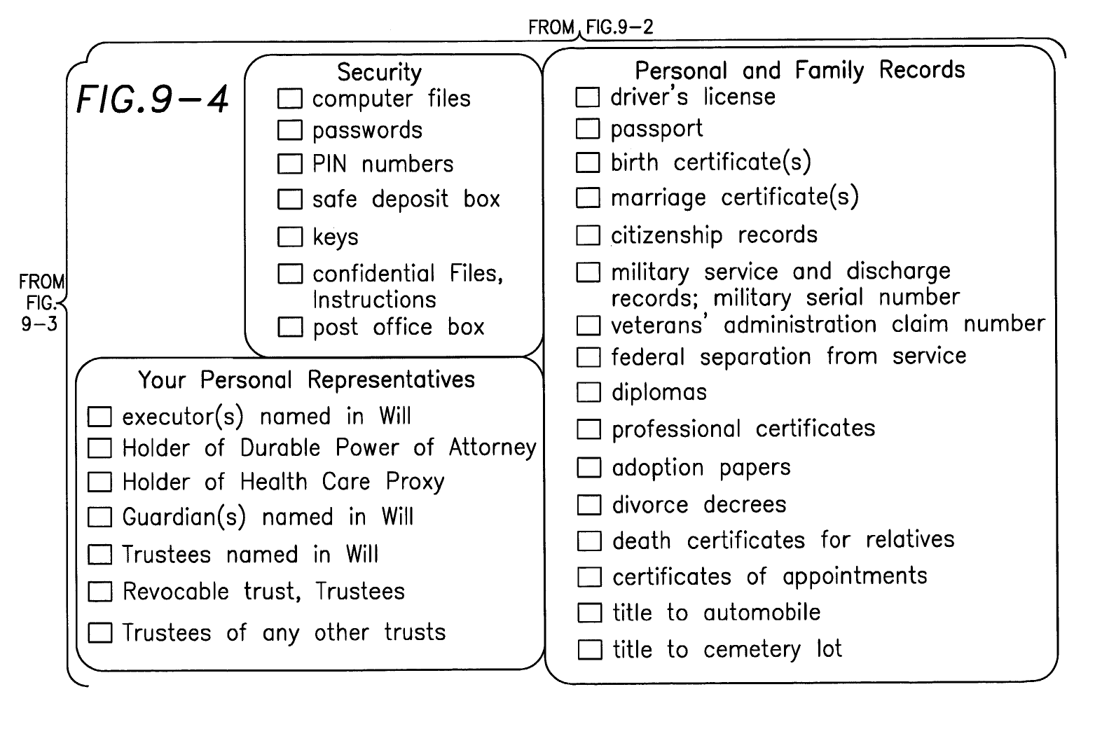

FIG. 9 shows an example of a display screen (Web page) that provides a full view of items that may be found in a user's personal folder and guides a user through the submission of such items. The display screen provides lists of personal items in various categories and checkboxes in which a user may indicate that he or she intends to submit the checked items. The Web page also includes links to other portions of the individual's e-vault and also to relevant features such as an online address book, calendar, notes, etc.

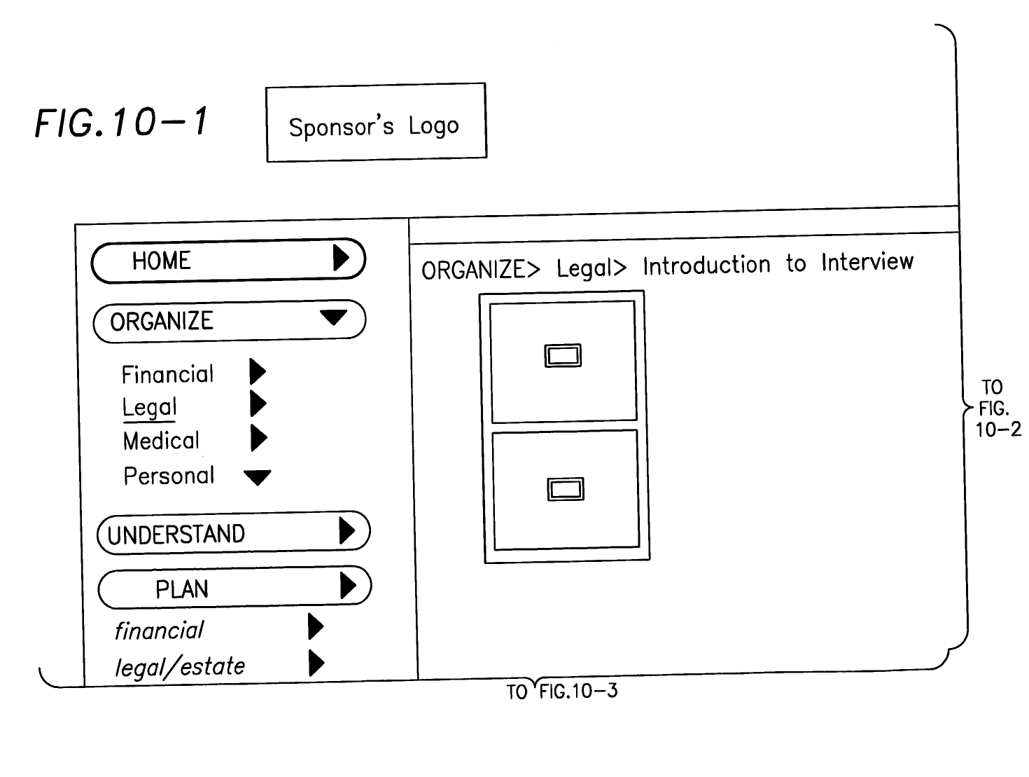

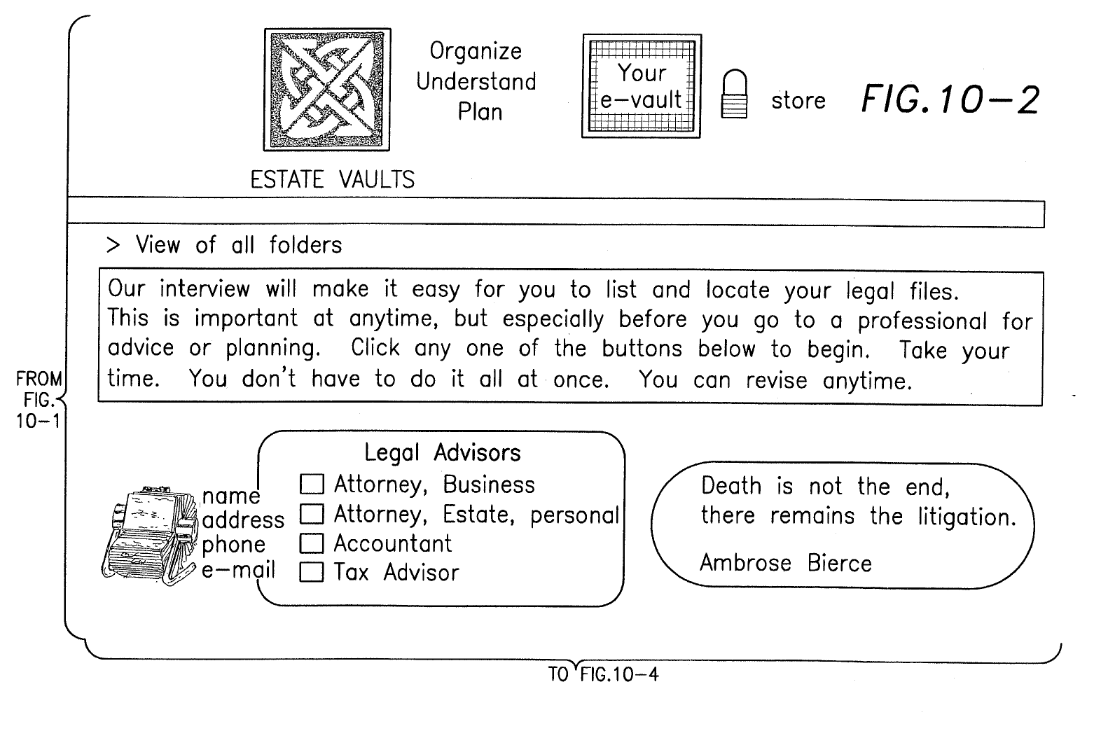

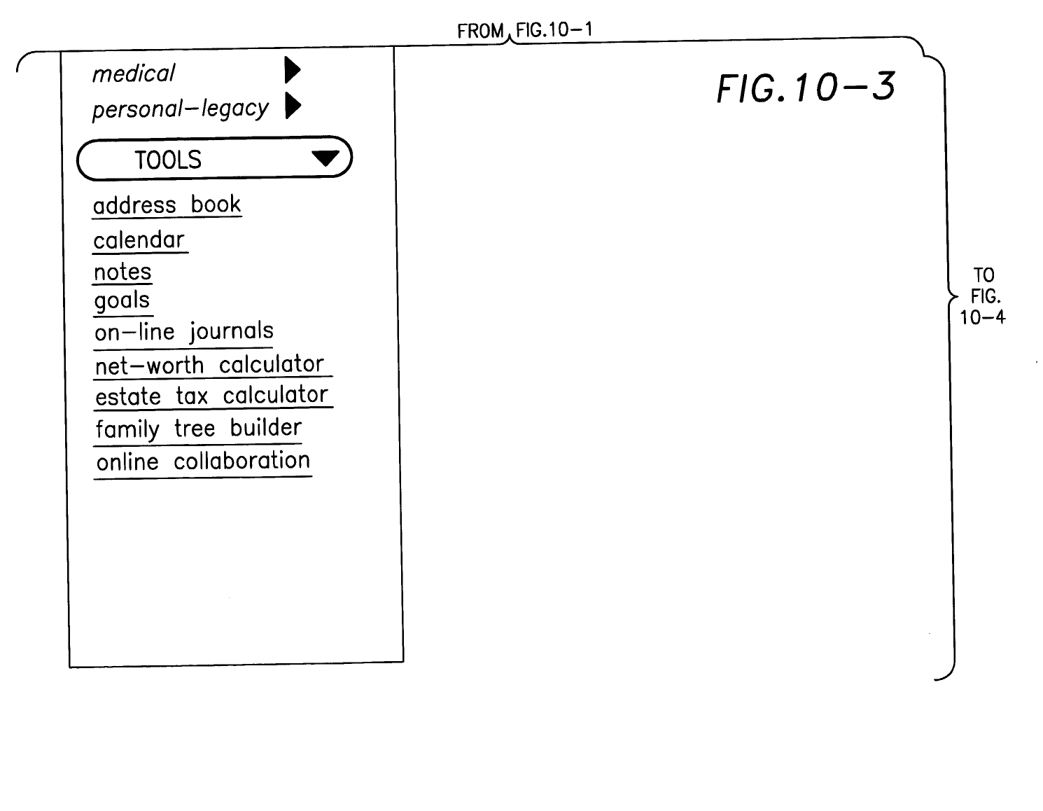

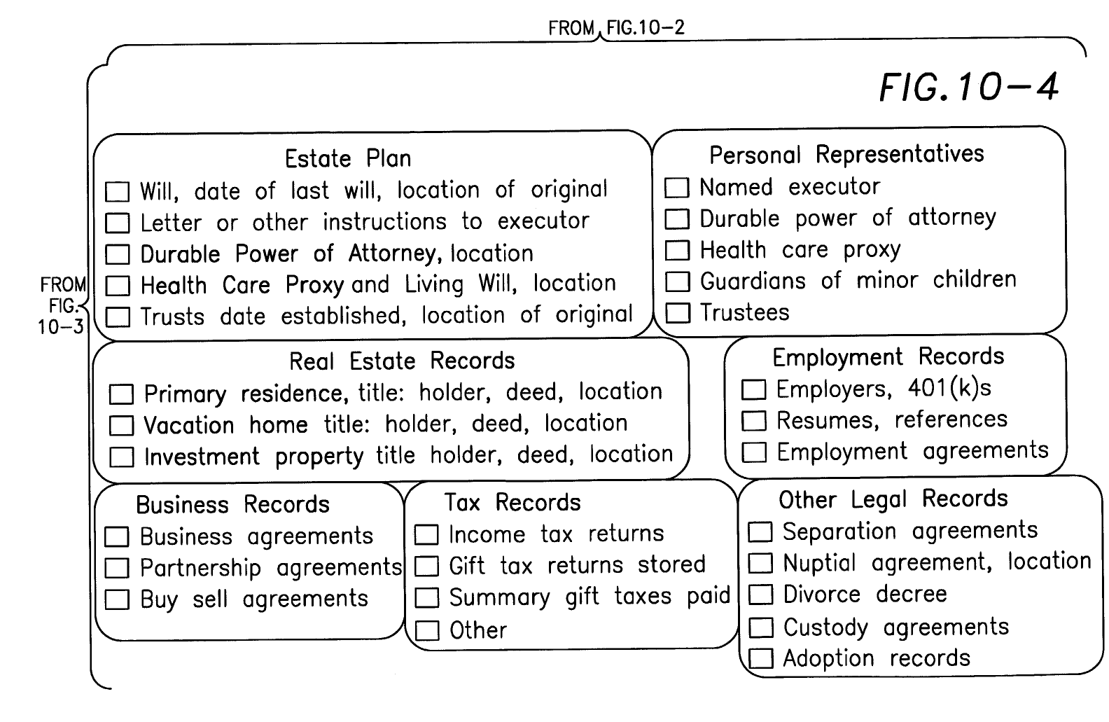

FIG. 10 shows an example of a display screen (Web page) that provides a full view of items that may be found in a user's legal folder and guides the user through submission of such items. The display screen provides lists of items in various categories related to an individual's situation with respect to legal matters and checkboxes in which a user may indicate that he or she intends to submit the checked items. The Web page also includes links to other portions of the individual's e-vault and also to relevant features as described above.

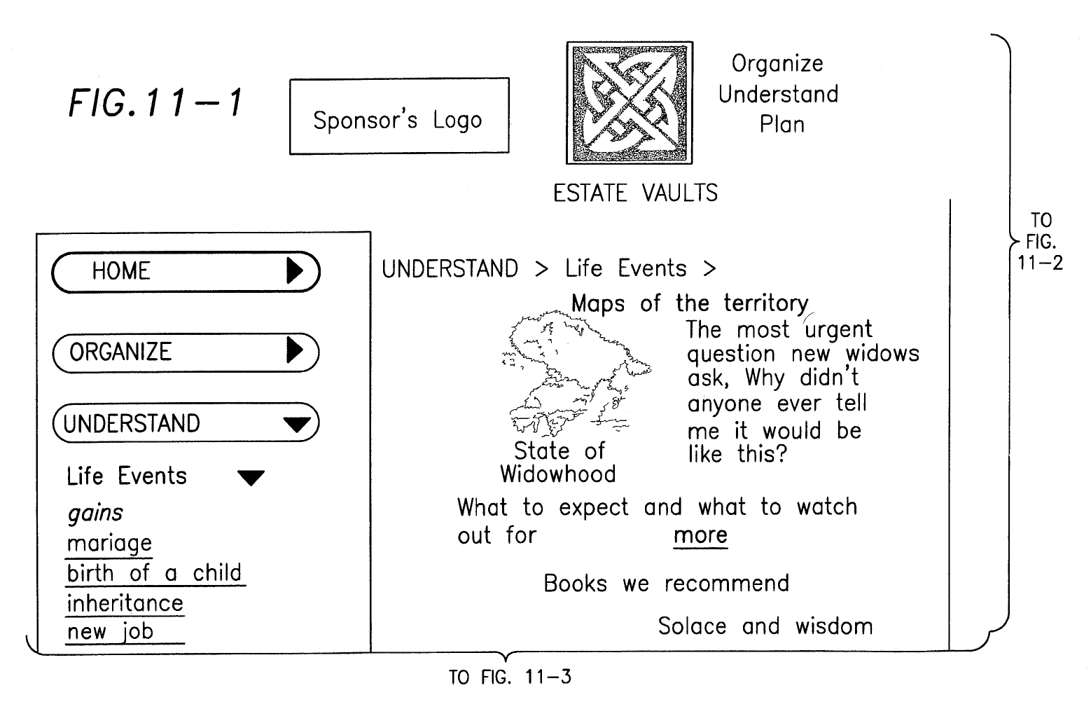

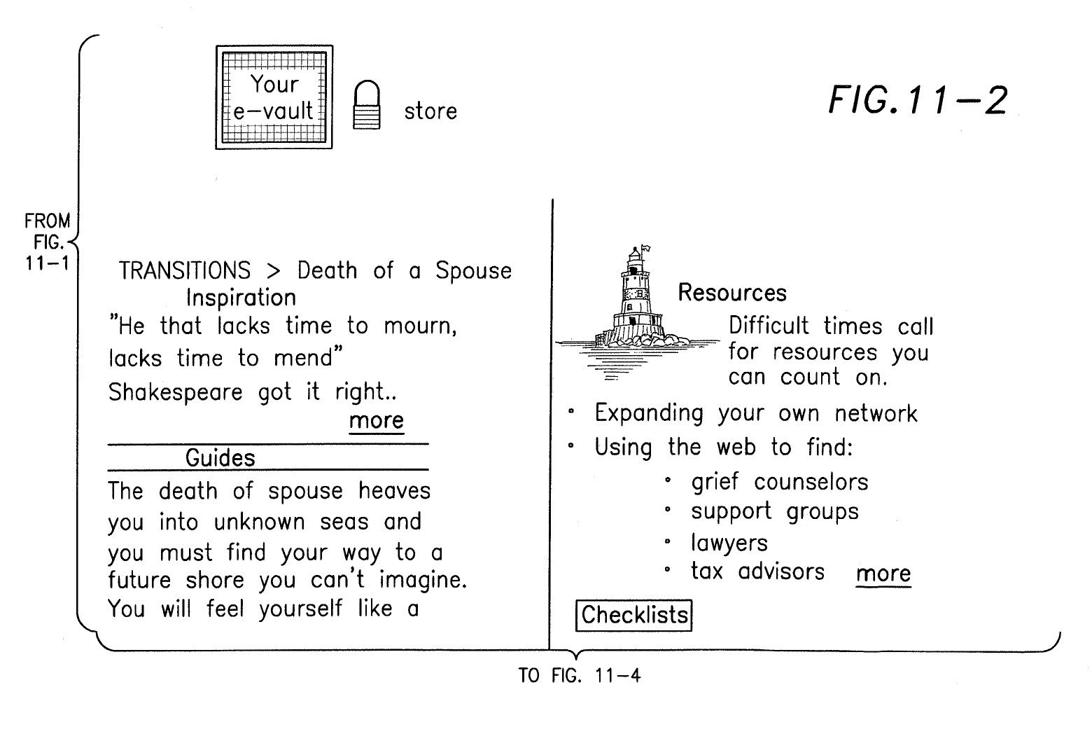

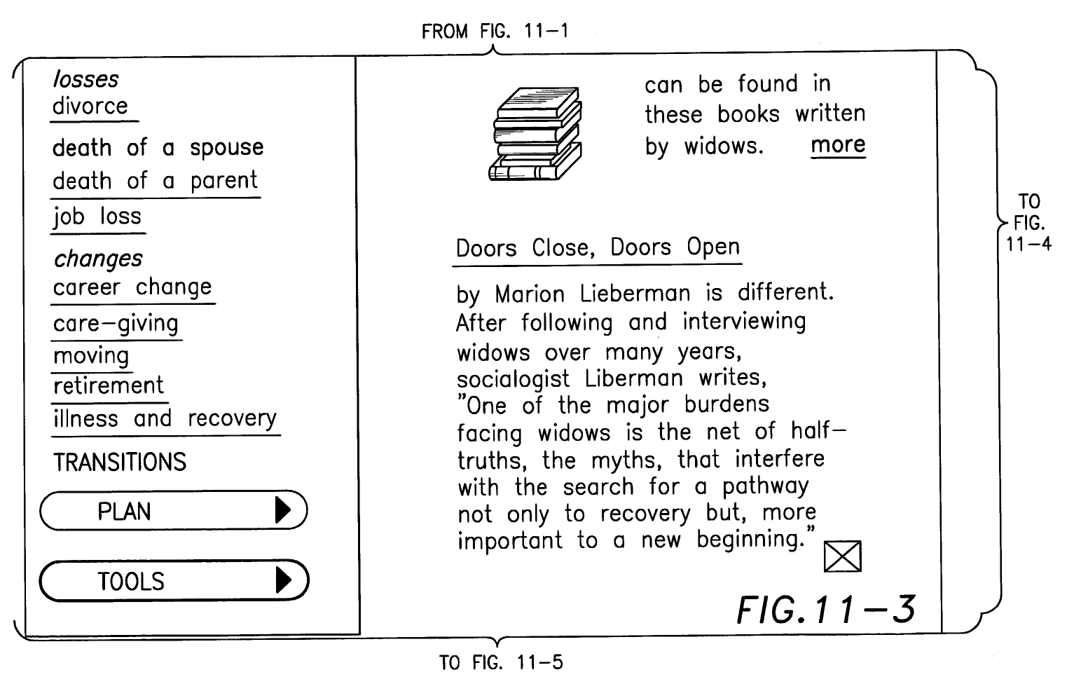

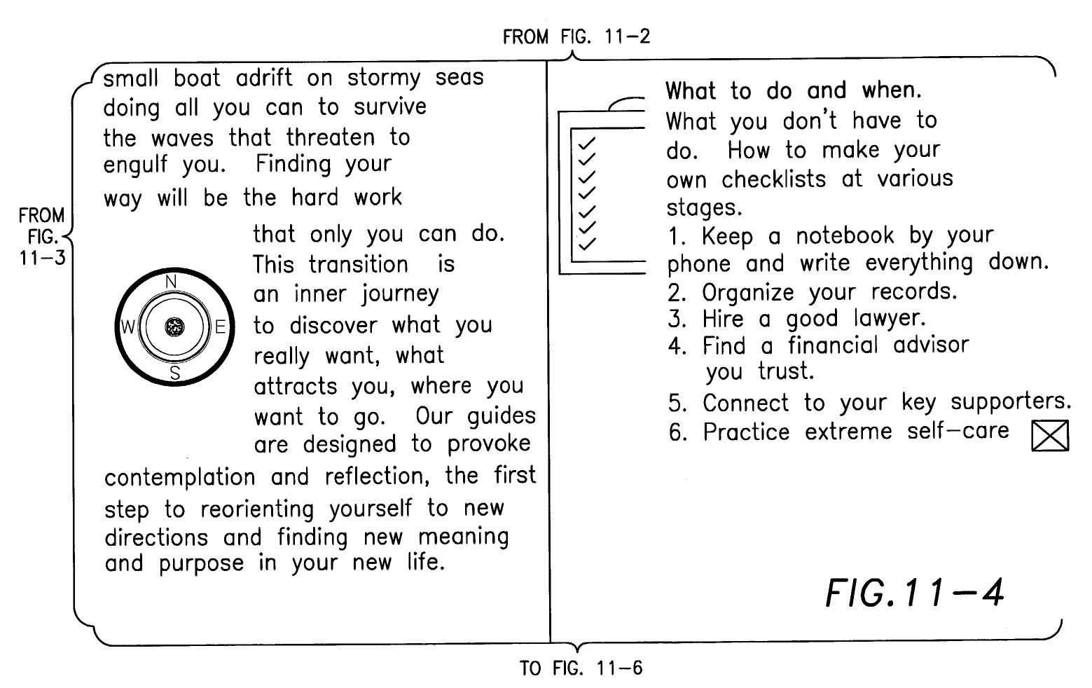

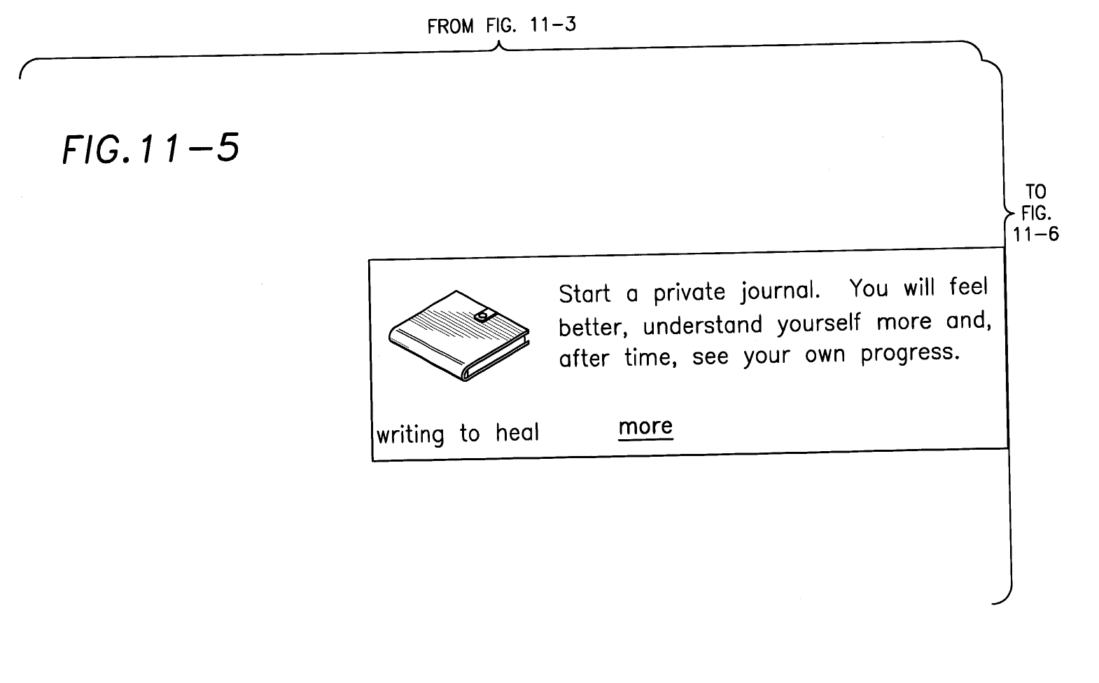

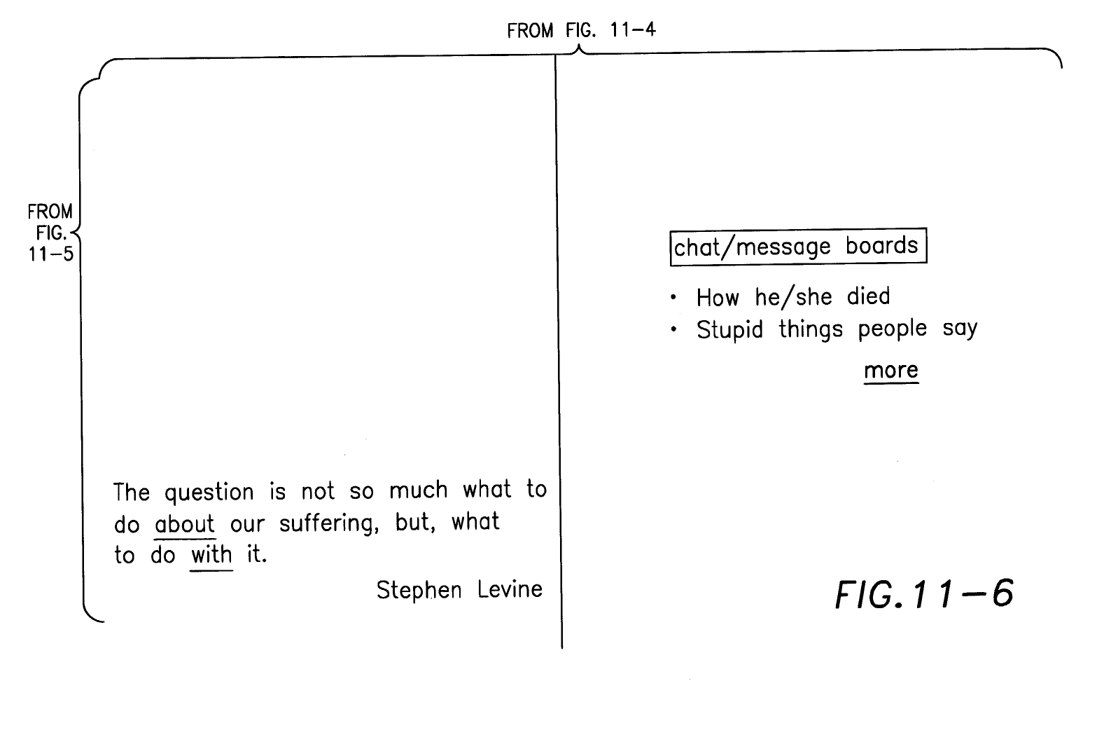

FIG. 11 shows an example of a display screen (Web page) that helps a user understand and cope with the transitions associated with a life event (death of a spouse). The Web page includes a “map of the territory”, inspirational messages, resources (and appropriate links to Web resources), book recommendations, and checklists. The Web page also includes links to Web pages addressing other life events, etc.

The remainder of this section presents the architecture of the various folders and their integration in one embodiment of the invention in greater detail. As indicated below, the folders preferably contain information organized in a hierarchical fashion, and the software includes the capability to generate a variety of useful summaries based on the information contained in the folders. Certain information is indexed across folders. For example, the Personal Representatives and Advisors-Key Professionals sections under the Personal Folder, also appear in the Medical Folder, Financial Folder, and Legal Folder (and subfolders thereof) in their appropriate positions. It is to be understood that any particular implementation of the invention need not contain all the items indicated below and may contain additional items. This section also lists categories of relevant information and types of documents that may be found in each category.

Universal Integrated Organizer and Legacy Planner Architecture

Personal Folder

Personal Information

Family information and records

Personal Representatives

Advisors Key Professionals (cross indexed across folders)

Security

Personal Archives (anything you wish to save and store)

Last Wishes (funeral arrangements and organ donations)

Medical Folder

Medical professionals and providers

Summary Health at a glance

Personal Health History

Copies of your original medical records

Your personal screening and exam schedule

Copies of Health Proxy and Living Will

Financial Folder

Financial Advisors

Assets

Retirement Assets

Real Estate

Personal Property Schedule

Additional Assets

Liabilities

Legal Folder

Legal Advisors/Representatives

Estate Plan

Real Estate Records

Business Records

Employment Records

Other Legal Records

Tax Folder

Accountant/Tax Advisor

Tax records

Insurance Folder

Insurance Brokers and Agents

Life Insurance Policies

Health Insurance Policies

Property and Auto Insurance Policies

Financial Insurance Policies

Professional and Business Policies

Summaries available with the Universal Integrated Organizer

Address book

Family

Personal Representatives

Medical

Legal

Financial

Beneficiary Designations

in will

retirement assets

insurance policies

Estate Plan

will

durable power of attorney

trust

health care proxy and living will

estate tax calculator

organ donation

letter to executor

Personal Representatives

executor(s) Named in will, address; successor executor

holder of Durable Power of Attorney

holder of Health Care Proxy

guardian(s) named in will

trustees named in will

revocable trust, trustees

trustees of any other trusts

Summary Health at a glance

allergies/reactions

medical conditions /problems

current medications, vitamins and supplements

blood type

significant family medical conditions

primary-care provider/family doctor

health insurance

emergency contact

health care proxy

Insurance policies

linked to assets protected

with anniversary dates

annual cost

agent contact

Assets

jointly held, sole owner, in trust

net worth

Universal Integrated Organizer Address Book

Family

parents

spouse

children

siblings

aunts and uncles

Personal representatives

named executor

durable power of attorney

health care proxy

guardians of minor children and other dependents

trustee under will

other

Medical professionals and providers

primary care provider

gynecologist

specialists

dentist

complimentary care providers

hospitals

lifeline

health insurance company

Legal

attorney business

attorney estate

attorney real estate

other

Financial

accountant

financial planner

bank officer

investment advisor

stockbroker

life insurance agent

property and casualty agent

other

Personal Folder

Personal Information

Family information and records

Personal Representatives

Advisors Key Professionals (cross indexed across folders)

Security

Personal Archives (anything you wish to save and store)

Last Wishes (funeral arrangements and organ donations)

Personal Information

name

citizenship

birth date and birthplace

social security number

Home

address

home telephone

home email:

is this your legal residence?

where you vote

where you are licensed to drive? license number

where your car is registered? registration number, renewal date

other residence(s) address(es)

Occupation

workplace

name of company

length of employment

work address

work phone

work email

The symbol ˆ (shift 6) indicates that the document has been scanned up and stored

Your personal records

driver's license

passport

birth certificate

marriage certificate

citizenship records

military service and discharge records; military serial number

veterans' administration claim number

federal separation from service

diplomas

professional certificates

adoption papers

divorce decrees

death certificates for relatives

title to automobile

title to cemetery lot

Family information and Records

Your marital status

if married

spouse's name

birth date and birthplace

citizenship

does your spouse have a will in a foreign country?

social security number

date of marriage: marriage certificate

are there any pre or postmarital agreements?

children of this marriage

Spouse's

occupation

workplace

name

length of employment______

work Address

work phone

work email

If widowed

spouse's name

birth date and birthplace

date of marriage: marriage certificate

death certificate and cause of death

children of this marriage

If divorced or separated

spouse's name

birth date and birthplace

date of marriage: marriage certificate

children of this marriage

date of divorce or separation: divorce decree and/or separation agreement

alimony payments______ child Support______

any other obligations under divorce decree and/or separation agreement?

is your estate obligated to continue payments?

any other prior spouse (s)?name(s) of prior spouses.

widowed

divorced

obligations under divorce decree

Your parents

Father's name

birth date and birthplace. birth certificate

if deceased, date of death and cause of death: death certificate

address and phone

retired Y/N

social security number

Mother's name

birth date and birthplace. birth certificate

if deceased, date of death and cause of death: death certificate

address and phone

retired Y/N

social security number

Your children

Child's name

date and place of birth: birth certificate

if dependent currently,

health condition special needs

college accounts? with whom, account number

UGMA account? with whom, account number

child's assets as of

if independent

address, phone, email

occupation

spouse's name

grandchildren's names

child's name

date and place of birth: birth certificate

if dependent currently,

health condition special needs

college accounts? with whom, account number

UGMA account? with whom, account number

child's assets as of

if independent

address, phone, email

occupation

spouse's name

grandchildren's names

Have you named a guardian in a will?

if yes, name and address

Other legal dependents

dependent's name

relationship

date of birth/birth certificate

health condition

remarks

Other family members

Siblings

Name

Address

Telephone

email

Date of birth

name of spouse, date of birth

children

repeated as often as needed

Other relatives

Family tree

Family History

Personal Representatives

Executor(s) Named in will, address; successor executor

Holder of Durable Power of Attorney

Holder of Health Care Proxy

Guardian(s) named in will

Trustees named in will

Revocable trust, trustees

Trustees of any other trusts

Security

Computer Files

Passwords and special instructions

Security PIN numbers

bank

home security system

credit card

combination lock numbers

safe deposit box

bank, owner, location of key

Keys

car, home, safe deposit, file, other

Confidential Files

instructions regarding disposition of diaries, journals, etc

Post Office Box

location, key

Last wishes

Funeral

prepaid burial expenses, contract with whom

letter of instruction for memorial services

Organ donations

arrangements for on drivers license, with organ bank

link to The Living Bank, the national organ and tissue donor registry and information service.

link to Statement Regarding Anatomical Gifts, prepared by ABA

Medical Folder

Medical professionals and providers

primary care provider

gynecologist

specialists

dentist

complimentary care providers

hospitals

lifeline

Summary Health at a glance

allergies/reactions

medical conditions /problems

current medications, vitamins and supplements

blood type

significant family medical conditions

primary-care provider/family doctor

health insurance

emergency contact

health care proxy

Personal Health History

illness, surgery, hospitalizataion, chronic medical conditions,

family medical history tree and important medical information about other

relatives

medications, vitamins, supplements and herbs log

Copies of your original medical records

doctors consultation reports

hospital discharge summaries

eye/vision

dental

complimentary care

copies of laboratory reports

copies of X-rays

heart testing

screening and diagnostic procedures

Your personal screening and exam schedule

Copy of Health Proxy and Living Will

Financial Folder

Financial Advisors

Investment Advisor

name, firm, address, phone, email, comments

Stock Broker

name, firm, address, phone, email, comments

Bank Officer

name, bank, address, phone, email, comments

Financial Planner

name, firm, address, phone, email, comments

Accountant

name, firm, address, phone, email, comments

Other

Assets

Cash and Equivalents

Checking accounts

bank, account #, owner

Savings account

bank, account #, owner

Money market account

bank, account #, owner

Certificates of Deposit

bank, amount, owner, interest rate, length of term, maturity date

Stocks (possible to be imported from Quicken et al)

name, number of shares, owner, location,

date acquired, cost basis per share

S corporation stock

Mutual Funds (possible to be imported from Quicken et al)

name, number of shares, owner, location,

date acquired, cost basis per share

Stock options

name, number of shares, owner, location,

date granted, exercise date, option price/share

Bonds, US Treasury Debt

owner, location

cost, date acquired, face amount, maturity date

Limited Partnerships

name, owner, type, location

date of purchase, investment to date

Accounts/Notes Receivable

owner, debtor, location, original amount, maturity date,

interest rate, principal outstanding

comments

Investment accounts / Online accounts

owner, institution, account number, location, password

Retirement Assets

Pension

type of investment, institution, owner,

beneficiary

before-tax employee contribution, after tax employee contribution,

employer contribution, expected rate of return, % vested, % unvested

Profit-sharing

type of investment, institution, owner,

beneficiary

before-tax employee contribution, after tax employee contribution,

employer contribution, expected rate of return, % vested, % unvested

Keough

type of investment, institution, owner,

beneficiary

before-tax employee contribution, after tax employee contribution,

employer contribution, expected rate of return, % vested, % unvested

401(k)

type of investment, institution, owner,

beneficiary

before-tax employee contribution, after tax employee contribution,

employer contribution, expected rate of return, % vested, % unvested

Other SEP, SERP

type of investment, institution, owner,

beneficiary

before-tax employee contribution, after tax employee contribution,

employer contribution, expected rate of return, % vested, % unvested

IRAs

type of investment, institution, owner,

beneficiary(s)

Roth IRAs

type of investment, institution, owner,

beneficiary(s)

Real Estate

Primary Residence

address, owner, location of deed

date of purchase, cost of improvements, fair market value

annual costs: real estate taxes, insurance, maintenance

Vacation Home

address, owner, location of deed

date of purchase, cost of improvements, fair market value

annual costs: real estate taxes, insurance, maintenance

Investment Property

address, owner, location of deed

date of purchase, cost of improvements, fair market value

annual costs: real estate taxes, insurance, maintenance

annual income, annual depreciation

Personal Property Schedule

jewelry, antiques, collectibles

description, owner, location

estimated value

household furnishings

automobiles, boats, planes

year, make, model, location of title

value

collections and hobby equipment

description, owner, location

estimated value

Additional Assets

annuities

institution, owner, date acquired, location

original investment, fair market value, maturity/exercise date

futures

owner, date acquired, location

original investment, fair market value, maturity/exercise date

warrants

owner, date acquired, location

original investment, fair market value, maturity/exercise date

hard assets

owner, date acquired, location

original investment, fair market value.

copyrights/patents

owner, date acquired, location

original investment, fair market value.

Liabilities

Secured

Mortgages

Bank/Company, on what property,

interest rate, amount outstanding

Auto Loans

Bank/Company, on what,

interest rate, amount outstanding

Margin Accounts

Bank/Company, on what,

interest rate, amount outstanding

Unsecured

Personal Notes

creditor, debtor, location

date originated, original amount,

interest rate, amount and frequency of payment

Bank Notes

creditor, debtor, location

date originated, original amount,

interest rate, amount and frequency of payment

Contingent (guarantees)

creditor, debtor, location

date originated, original amount,

interest rate, amount and frequency of payment

Credit cards

creditor, debtor, location

date originated, original amount,

interest rate, amount and frequency of payment

Taxes due

creditor, debtor, location

date originated, original amount,

interest rate, amount and frequency of payment

Other

Legal Folder

Legal Advisors/Representatives

Attorney, Business

name, firm, address, phone, email, comments

Attorney, Estate

name, firm, address, phone, email, comments

Attorney, Real Estate

name, firm, address, phone, email, comments

Attorney, Other

Accountant

name, firm, address, phone, email, comments

Estate Plan

Will, date of last will, location of original

Letter or other instructions to executor

Durable Power of Attorney, location

Health Care Proxy and Living Will, location

Trusts date established, location of original

Personal Representatives

named executor

durable power of attorney

health care proxy

guardians of minor children and other dependents

trustee under will

trustee of grantor trust

other

Real Estate Records

1. primary residence

title holder

mortgage outstanding; title deed, location

2. vacation home

title holder

mortgage outstanding; title deed, location

3. other property (investment)

title holder

mortgage outstanding; title deed, location

Business Records

business agreement

partnership agreement

buy-sell agreement

Employment Records

current employer

resume

employment agreements

Other Legal Records

separation agreements

nuptial agreement, location

divorce decree

custody agreements

Tax records

Accountant/Tax Advisor

name, firm, address, phone, email, comments

income tax returns stored

gift tax returns stored

summary gift taxes paid

other

Insurance Records

Insurance Brokers and Agents

Life Insurance Agent

name, firm, address, phone, email, comments

Property and Casualty Agent

name, firm, address, phone, email, comments

Other

Life Insurance Policies

Life Insurance

company, policy #, face amount, loans against, anniversary

date, annual premium

Other (provided by employer or group)

Health Insurance Policies

Medical

company, policy #, location anniversary date, annual premium

Supplemental Medical

Vision/Dental

Disability

Long term care

Medicare

Medicare supplement

Property and Auto Insurance Policies

Property insurance/Homeowners

company, policy #, location, anniversary date, annual premium riders

Auto insurance

company, policy #, location, anniversary date, annual premium

Other

Financial Insurance Policies

Mortgage or Loan insurance

company, policy #, location, anniversary date, annual premium

Credit card insurance

Umbrella Liability coverage

company, policy #, location, anniversary date, annual premium

Professional and Business Policies

Type

company, policy #, location, anniversary date, annual premium

While the invention has been presented with reference to certain preferred embodiments, it is to be understood that the description above is not intending to be limiting, and a number of variations will be apparent to one of ordinary skill in the art. Such variations are included within the scope of the appended claims.

I claim:

1. A method for providing a user with assistance for personal legacy planning and personal information organizing comprising the steps of:
transmitting, over a computer network, requests for or lists of informational items and documents appropriate for inclusion in a personal legacy plan;
receiving, over the computer network, informational items and documents appropriate for inclusion in a personal legacy plan; and
storing the informational items and documents in a personal storage space assigned to the user on a secure server, wherein access to the informational items is restricted to the user or to a trusted individual designated by the user upon the occurrence of a condition predetermined by the user.

2. The method of claim 1, further including the step of:
organizing the informational items and documents.

3. The method of claim 2, wherein the informational items and documents are organized into folders including one or more of: a personal folder, a legal folder, a medical folder, and a financial folder.

4. The method of claim 3, further including the step of:
integrating the informational items and documents across folders, so that information initially entered under a category in one of the folders is available in an appropriate category in one or more of the other folders.

5. The method of claim 1, wherein the informational items and documents include a will.

6. The method of claim 1, wherein the informational items and documents include a trust.

7. The method of claim 1, wherein the informational items and documents include a deed.

8. The method of claim 1, wherein the receiving step comprises:
receiving a scanned document.

9. The method of claim 1, wherein the transmitting step and the receiving step occur securely.

10. The method of claim 1, wherein the receiving step comprises receiving informational items or documents that have been encrypted prior to transmission.

11. The method of claim 1, wherein the transmitting step is includes transmitting a Web page.

12. The method of claim 1, wherein the receiving step includes receiving the informational items and documents at a Web site.

13. The method of claim 1, wherein one or more of the receiving step and the transmitting step takes place via the Internet.

14. The method of claim 1, further comprising the step of providing a forum for secure, online collaboration between a user and other individuals.

15. The method of claim 1, wherein the storing step comprises storing the informational items and documents in an encrypted format.

16. The method of claim 1, further comprising providing one or more Web pages that include information addressing a transition associated with a life event.

17. The method of claim 1, further including the step of:
providing an electronic mailbox for the user;
receiving, in the electronic mailbox, an informational item or document from a third party, wherein the informational item or document is appropriate for inclusion in the user's personal information storage space.

18. The method of claim 17, wherein the informational item or document is selected from the list consisting of: a medical record, a financial record, a tax return, an account statement, an insurance policy, and a stock certificate.

19. The method of claim 17, further including the step of:
notifying the user of the arrival of an informational item or document in the electronic mailbox.

20. The method of claim 1, further including the steps of:
storing information identifying a trusted individual designated by the user; and
storing information identifying a condition predetermined by the user.

21. The method of claim 20, wherein the condition is the death of the user.

22. The method of claim 20, wherein the condition is the incapacitation of the user.

23. A method of providing limited access to a user's personal legacy information, wherein, information identifying a trusted individual designated by the user has been stored, and wherein information identifying a condition predetermined by the user has been stored comprising:
identifying the trusted individual; and
providing the trusted individual with access to the stored informational items upon the occurrence of the condition.

24. The method of claim 23, further comprising the step of:
verifying the identity of the trusted individual.

25. The method of claim 23, wherein the providing step comprises decrypting the stored informational items and documents.

26. The method of claim 23, wherein the providing step comprises providing a cryptographic key to the trusted individual.

27. A method for personal legacy planning comprising the steps of:
storing informational items and documents appropriate for inclusion in a personal legacy plan on a secure server, wherein access to the informational items is restricted to the user;
storing information identifying a trusted individual designated by the user; and
storing information identifying a condition predetermined by the user.

28. The method of claim 27, further including the step of:
organizing the informational items and documents.

29. The method of claim 28, wherein the items are organized into folders including a personal folder, a legal folder, a medical folder, and a financial folder.

30. The method of claim 29, further including the step of:
integrating the information across folders, so that information initially entered under a category in one of the folders is available in an appropriate category in one or more of the other folders.

31. The method of claim 27, further comprising:
providing the trusted individual with access to the stored informational items upon the occurrence of the condition.

32. A system for providing a user with assistance for personal legacy planning comprising:
a Web site comprising a set of Web pages that allow a user to enter or submit informational items appropriate for inclusion in a personal legacy plan securely;
a secure storage space to store some or all of the informational items submitted by the user, the storage space comprising a computer-readable medium; and
means for providing access to the stored items to the user and a trusted individual designated by the individual.

33. A method for providing a user with assistance for personal legacy planning comprising the steps of:
receiving a plurality of encrypted informational items or documents suitable for personal legacy planning over a computer network;
storing the documents on a computer-readable medium, wherein the documents are accessible only to the user or to a trusted individual designated by the user upon the occurrence of a condition predetermined by the user.

34. The method of claim 33, further comprising the steps of:
storing information from the user identifying a trusted individual;
storing information from the user identifying a condition predetermined by the user; and
providing access to the informational items and documents to the trusted individual upon the occurrence of the condition.

35. The method of claim 33, further comprising the step of:
prompting the user to transmit a document.

36. The method of claim 33, further comprising the step of:
notifying the user that a document of a type included on a predetermined list of suggested documents should be transmitted.

37. The method of claim 33, further comprising the step of:
notifying the user that a document of each type included on a predetermined list of suggested documents has been received.

38. The method of claim 33, wherein the receiving step comprises receiving encrypted documents.

39. The method of claim 33, wherein the storing step comprises storing encrypted documents.

40. The method of claim 33, further comprising the step of:
providing access to the stored documents to the user upon provision of appropriate identifying information.

41. The method of claim 40, wherein the identifying information comprises a password.

42. The method of claim 40, wherein the identifying information comprises a personal identification number.

43. The method of claim 41, wherein the identifying information comprises a biometric token.

44. The method of claim 33, further comprising the step of:
providing access to the stored documents to a trusted individual designated by the user following the occurrence of a condition predetermined by the user upon provision of appropriate identifying information by the trusted individual.

45. The method of claim 44, wherein the trusted entity is a financial intermediary.

46. The method of claim 44, wherein the identifying information comprises a password.

47. The method of claim 44, wherein the identifying information comprises a personal identification number.

48. The method of claim 44, wherein the identifying information comprises a photo ID.

49. The method of claim 44, wherein the identifying information comprises a biometric token.

50. The method of claim 33, further comprising the step of:
notifying the user of a need to update the documents.

51. The method of claim 50, wherein the notifying step comprises:
sending an e-mail to the user.

52. The method of claim 50, further comprising the step of:
notifying the user of a change in a law affecting estate planning.
